(19) United States
(12) Patent Application Publication
(10) Pub. No.: US 2013/0271565 A1
(43) Pub. Date: Oct. 17, 2013

(54) VIEW SYNTHESIS BASED ON ASYMMETRIC TEXTURE AND DEPTH RESOLUTIONS

(71) Applicant: QUALCOMM INCORPORATED, San Diego, CA (US)

(72) Inventors: Ying CHEN, San Diego, CA (US); Karthic VEERA, San Diego, CA (US); Jian WEI, San Diego, CA (US)

(73) Assignee: QUALCOMM INCORPORATED, San Diego, CA (US)

(21) Appl. No.: 13/774,430

(22) Filed: Feb. 22, 2013

Related U.S. Application Data
(60) Provisional application No. 61/625,064, filed on Apr. 16, 2012.

(51) Int. Cl. H04N 13/00

(52) U.S. Cl. CPC H04N 13/0048
USPC 348/43; 348/42

(57) ABSTRACT

An apparatus for processing video data includes a processor configured to associate, in a minimum processing unit (MPU), one pixel of a depth image of a reference picture with one or more pixels of a first chroma component of a texture image of the reference picture, associate, in the MPU, the one pixel of the depth image with one or more pixels of a second chroma component of the texture image, and associate, in the MPU, the one pixel of the depth image with a plurality of pixels of a luma component of the texture image. The number of the pixels of the luma component is different than the number of the one or more pixels of the first chroma component and the number of the one or more pixels of the second chroma component.

This application claims the benefit of U.S. Provisional Application No. 61/625,064, filed Apr. 16, 2012, the entire contents of which are hereby incorporated by reference.

### TECHNICAL FIELD

This disclosure relates to video coding and, more particularly, to techniques for coding video data.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards, to transmit, receive and store digital video information more efficiently.

Video compression techniques include spatial prediction and/or temporal prediction to reduce or remove redundancy inherent in video sequences and improve processing, storage, and transmission performance. Additionally, digital video can be coded in a number of forms, including multi-view video coding (MVC) data. In some applications, MVC data may, when viewed, form a three-dimensional video. MVC video can include two and sometimes many more views. Transmitting, storing, as well as encoding and decoding all of the information associated with MVC video, can consume a large amount of computing and other resources, as well as lead to issues such as increased latency in transmission. As such, rather than coding or otherwise processing all of the views separately, efficiency may be gained by coding one view and deriving other views from the coded view. However, deriving additional views from an existing view can include a number of technical and resource related challenges.

### SUMMARY

In general, this disclosure describes techniques related to three-dimensional (3D) video coding (3DVC) using texture and depth data for depth image based rendering (DIBR). For instance, the techniques described in this disclosure may be related to the use of depth data for warping and/or hole-filling of texture data to form a destination picture. The texture and depth data may be components of a first view in a MVC plus depth coding system for 3DVC. The destination picture may form a second view that, along with the first view, forms a pair of views for 3D display. In some examples, the techniques may associate one depth pixel in a depth image of a reference picture with a plurality of pixels in a luma component, one or more pixels in a first chroma component, and one or more pixels in a second chroma component of a texture image of the reference picture, e.g., as a minimum processing unit for use in DIBR. In this manner, processing cycles may be used efficiently for view synthesis, including for warping and/or hole-filling processes to form a destination picture.

In one example, a method for processing video data includes associating, in a minimum processing unit (MPU), one pixel of a depth image of a reference picture with one or more pixels of a first chroma component of a texture image of the reference picture. The MPU indicates an association of pixels needed to synthesize a pixel in a destination picture. The destination picture and the texture component of the reference picture when viewed together form a three-dimensional picture. The method also includes associating, in the MPU, the one pixel of the depth image with one or more pixels of a second chroma component of the texture image and associating, in the MPU, the one pixel of the depth image with a plurality of pixels of a luma component of the texture image. A number of the pixels of the luma component is different than a number of the one or more pixels of the first chroma component and a number of the one or more pixels of the second chroma component.

In another example, an apparatus for processing video data includes at least one processor configured to associate, in a minimum processing unit (MPU), one pixel of a depth image of a reference picture with one or more pixels of a first chroma component of a texture image of the reference picture. The MPU indicates an association of pixels needed to synthesize a pixel in a destination picture. The destination picture and the texture component of the reference picture when viewed together form a three-dimensional picture. The at least one processor is also configured to associate, in the MPU, the one pixel of the depth image with one or more pixels of a second chroma component of the texture image and associate, in the MPU, the one pixel of the depth image with a plurality of pixels of a luma component of the texture image. The number of the pixels of the luma component is different than the number of the one or more pixels of the first chroma component and the number of the one or more pixels of the second chroma component.

In another example, an apparatus for processing video data includes means for associating, in a minimum processing unit (MPU), one pixel of a depth image of a reference picture with one or more pixels of a first chroma component of a texture image of the reference picture. The MPU indicates an association of pixels needed to synthesize a pixel in a destination picture. The destination picture and the texture component of the reference picture when viewed together form a three-dimensional picture. The apparatus also includes means for associating, in the MPU, the one pixel of the depth image with one or more pixels of a second chroma component of the texture image and means for associating, in the MPU, the one pixel of the depth image with a plurality of pixels of a luma component of the texture image. A number of the pixels of the luma component is different than a number of the one or more pixels of the first chroma component and a number of the one or more pixels of the second chroma component.

In another example, a computer-readable storage medium has stored thereon instructions that when executed cause one or more processors to perform operations including associating, in a minimum processing unit (MPU), one pixel of a depth image of a reference picture with one or more pixels of a first chroma component of a texture image of the reference picture. The MPU indicates an association of pixels needed to synthesize a pixel in a destination picture. The destination picture and the texture component of the reference picture when viewed together form a three-dimensional picture. The instructions, when executed, also cause the one or more processors to perform operations including associating, in the MPU, the one pixel of the depth image with one or more pixels of a second chroma component of the texture image and associating, in the MPU, the one pixel of the depth image with a plurality of pixels of a luma component of the texture image. A number of the pixels of the luma component is different than a number of the one or more pixels of the first chroma component and a number of the one or more pixels of the second chroma component.

In another example, a video encoder includes at least one processor that is configured to associate, in a minimum processing unit (MPU), one pixel of a depth image of a reference picture with one or more pixels of a first chroma component of a texture image of the reference picture. The MPU indicates an association of pixels needed to synthesize a pixel in a destination picture. The destination picture and the texture component of the reference picture when viewed together form a three-dimensional picture. The at least one processor that is also configured to associate, in the MPU, the one pixel of the depth image with one or more pixels of a second chroma component of the texture image and associate, in the MPU, the one pixel of the depth image with a plurality of pixels of a luma component of the texture image. A number of the pixels of the luma component is different than a number of the one or more pixels of the first chroma component and a number of the one or more pixels of the second chroma component. The at least one processor that is also configured to process the MPU to synthesize at least one MPU of the destination picture and encode the MPU of the reference picture and the at least one MPU of the destination picture. The encoded MPUs form a portion of a coded video bitstream comprising multiple views.

In another example, a video decoder includes an input interface and at least one processor. The input interface is configured to receive a coded video bitstream comprising one more views. The at least one processor is configured to decode the coded video bitstream. The decoded video bitstream comprises a plurality of pictures, each of which comprises a depth image and a texture image. The at least one processor that is also configured to select a reference picture from the plurality of pictures of the decoded video bitstream and associate, in a minimum processing unit (MPU), one pixel of a depth image of a reference picture with one or more pixels of a first chroma component of a texture image of the reference picture. The MPU indicates an association of pixels needed to synthesize a pixel in a destination picture. The destination picture and the texture component of the reference picture when viewed together form a three-dimensional picture. The at least one processor that is also configured to associate, in the MPU, the one pixel of the depth image with one or more pixels of a second chroma component of the texture image and associate, in the MPU, the one pixel of the depth image with a plurality of pixels of a luma component of the texture image. A number of the pixels of the luma component is different than a number of the one or more pixels of the first chroma component and a number of the one or more pixels of the second chroma component. The at least one processor that is also configured to process the MPU to synthesize at least one MPU of the destination picture.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example video encoding and decoding system that may utilize the techniques described in this disclosure.

FIG. 2 is a flowchart that illustrates a method of synthesizing a destination picture from a reference picture based on texture and depth component information of the reference picture.

FIG. 3 is a conceptual diagram illustrating an example of view synthesis.

FIG. 4 is a conceptual diagram illustrating an example of a MVC prediction structure for multiview coding.

FIG. 5 is a block diagram illustrating an example video encoder that may implement the techniques described in this disclosure.

FIG. 6 is a block diagram illustrating an example video decoder that may implement the techniques described in this disclosure.

FIG. 7 is a conceptual flowchart that illustrates upsampling which may be performed in some examples for depth image based rendering (DIBR).

FIG. 8 is a conceptual flowchart illustrating an example of warping according to this disclosure for a quarter resolution case.

### DETAILED DESCRIPTION

This disclosure relates to 3DVC techniques for processing of picture information in the course of transmitting and/or storing MVC plus depth video data, which may be used to form three-dimensional video. In some cases, a video can include multiple views that when viewed together appear to have a three-dimensional effect. Each view of such a multi-view video includes a sequence of temporally related two-dimensional pictures. Additionally, the pictures making up the different views are temporally aligned such that in each time instance of the multi-view video each view includes a two-dimensional picture that is associated with that time instance. Instead of sending first and second views for 3D video, a 3DVC processor may generate a view that includes a texture component and a depth component. In some cases, a 3DVC processor may be configured to send multiple views, where one or more of the views each include a texture component and a depth component, e.g., according to an MVC plus depth process.

Using the texture component and depth component of a first view, a 3DVC decoder may be configured to generate a second view. This process may be referred to as depth image based rendering (DIBR). The examples of this disclosure are generally related to DIBR. In some examples, the techniques described in this disclosure may be related to 3D video coding according to a 3DVC extension to H.264/AVC, which is presently under development, and sometimes referred to as the MVC compatible extension including depth (MVC+D). In other examples, the techniques described in this disclosure may be related to 3D video coding according to another 3DVC extension to H.264/AVC, which is sometimes referred to as the AVC-compatible video-plus-depth extension to H.264/AVC (3D-AVC). The following examples are sometimes described in the context of video coding based on extensions to H.264/AVC. However, the techniques described herein may also be applied in other contexts, particularly where DIBR is useful in 3DVC applications. For example, the techniques of this disclosure may be employed in conjunction with a multiview video coding extension of high efficiency video coding (HEVC) (MV-HEVC) or a multiview plus depth coding with HEVC-based technology extension (3D-HEVC) of the High-Efficiency Video Coding (HEVC) video coding standard.

In the course of transmitting, storing, or otherwise processing digital data that can be employed to generate 3D video, data making up some or all of a video is commonly encoded and decoded. Encoding and decoding multi-view video data, for example, is commonly referred to as multi-view coding (MVC). Some 3DVC processes, such as those described above, may make use of MVC plus depth information. Accordingly, some aspects of MVC are described in this disclosure for purposes of illustration. MVC video can include two and sometimes many more views, each of which includes a number of two-dimensional pictures. Transmitting, storing, as well as encoding and decoding all of this information can consume a large amount of computing and other resources, as well as lead to issues such as increased latency in transmission.

Rather than coding or otherwise processing all of the views separately, efficiency may be gained by coding one view and deriving the other views from the coded view using, e.g., inter-view coding. For example, a video encoder can encode information for one view of a MVC video and a video decoder can be configured to decode the encoded view, and utilize information included in the encoded view to derive a new view that, when viewed with the encoded view, forms a three-dimensional video.

The process of deriving new video data from existing video data is described in the following examples as synthesizing the new video data. However, this process could be referred to with other terms, including, e.g., generating, creating, etc., new video data from existing video data. Additionally, the process of synthesizing new data from existing data can be referred to at a number of different levels of granularity, including, synthesis of an entire view, portions of the view including individual pictures, and portions of the individual pictures including individual pixels. In the following examples, new video data is sometimes referred to as destination video data, or a destination image, view or picture, and existing video data from which the new video data is synthesized is sometimes referred to as reference video data, or a reference image, view or pictures. Thus, a destination picture may be referred to as synthesized from a reference picture. In the examples of this disclosure, the reference picture may provide a texture component and a depth component for use in synthesizing the destination picture. The texture component of the reference picture may be considered a first picture. The synthesized destination picture may form a second picture that includes a texture component that can be generated with the first picture to support 3D video. The first and second pictures may present different views at the same time instance.

View synthesis in MVC plus depth or other processes can be executed in a number of ways. In some cases, destination views or portions thereof are synthesized from reference views or portions thereof based on what is sometimes referred to as a depth map or multiple depth maps included in the reference view. For example, a reference view that can form part of a multi-view video can include a texture view component and a depth view component. At the individual picture level, a reference picture that forms part of the reference view can include a texture image and depth image. The texture image of the reference picture (or destination picture) includes the image data, e.g., the pixels that form the viewable content of the picture. Thus, from the viewer's perspective, the texture image forms the picture of that view at a given time instance.

The depth image includes information that can be used by a decoder to synthesize the destination picture from the reference picturing including the texture image and the depth image. In some cases, synthesizing a destination picture from a reference picture includes “warping” the pixels of the texture image using the depth information from the depth image to determine the pixels of the destination picture. Additionally, warping can result in empty pixels, or “holes” in the destination picture. In such cases, synthesizing a destination picture from a reference picture includes a hole-filling process, which can include predicting pixels (or other blocks) of the destination picture from previously synthesized neighboring pixels of the destination picture.

To distinguish between the multiple levels of data included in a MVC plus depth video, the terms view, picture, image, and pixels are used in the following examples in increasing order of granularity. The term component is used at different levels of granularity to refer to different parts of the video data that ultimately form a view, picture, image, and/or pixel. As noted above, a MVC video includes multiple views. Each view includes a sequence of temporally related two-dimensional pictures. A picture can include multiple images, including, e.g., a texture and a depth image.

Views, pictures, images, and/or pixels can include multiple components. For example, the pixels of a texture image of a picture can include luminance values and chrominance values (e.g., YCbCr or YUV). In one example, therefore, a texture view component including a number of texture images of a number of pictures can include one luminance (hereinafter “luma”) component and two chrominance (hereinafter “chroma”) components, which at the pixel level include one luma value, e.g., Y, and two chroma values, e.g., Cb and Cr.

The process of synthesizing a destination picture from a reference picture can be executed on a pixel-by-pixel basis. The synthesis of the destination picture can include processing of multiple pixel values from the reference picture, including, e.g., luma, chroma, and depth pixel values. Such a set of pixel values from which a portion of the destination picture is synthesized is sometimes referred to as a minimum processing unit (hereafter “MPU”), in the sense that this set of values is the minimum set of information required for synthesis. In some cases, the resolution of the luma and chroma, and the depth view components of a reference view, may not be the same. In such asymmetric resolution texture and depth situations, synthesizing a destination picture from a reference picture may include extra processing to synthesize each pixel or other blocks of the destination picture.

As one example, the Cb and Cr chroma components and the depth view component are at a lower resolution than the Y luma component. For example, the Cb, Cr, and depth view components may each be at a quarter resolution, relative to the resolution of the Y component, depending on the sampling format. When these components are at different resolutions, some image processing techniques may include upsampling to generate a set of pixel values associated with a reference picture, e.g., to generate the MPU from which a pixel of the destination picture can be synthesized. For example, the Cb, Cr, and depth components can be upsampled to be the same resolution as the Y component and the MPU can be generated using these upsampled components (i.e., Y, upsampled Cb, upsampled Cr and upsampled depth). In such a case, view synthesis is executed on the MPU, and then the Cb, Cr, and depth components are downsampled. Such upsampling and downsampling may increase latency and consume additional power in the view synthesis process.

Examples according to this disclosure perform view synthesis on a MPU. However, to support asymmetric resolutions for the depth and texture view components, the MPU may not necessarily require association of only one pixel from each of the luma, chroma, and depth view components. Rather, a video decoder or other device can associate one depth value with multiple luma values and multiple chroma values, and more particularly, the video decoder can associate different numbers of luma values and chroma values with the depth value. In other words, the number of pixels in the luma component that are associated with one pixel of the depth view component, and the number of pixels in the chroma component that are associated with one pixel in the depth view component, can be different.

In one example, one depth pixel from a depth image of a reference picture corresponds to one or multiple pixels (N) of a chroma component and multiple pixels (M) of a luma component. When traversing the depth map and mapping the pixels, e.g., when warping texture image pixels to pixels of a destination picture based on depth image pixels, instead of generating each MPU as a combination of one luma value, one Cb value, and one Cr value for the same pixel location, the video decoder or other device can associate with one depth value, in an MPU, M luma values and N chroma values corresponding to the Cb or Cr chroma components, where M and N are different numbers. Therefore, in view synthesis in accordance with the techniques described in this disclosure, each warping may project one MPU of the reference picture to a destination picture, without the need for upsampling and/or downsampling to artificially create resolution symmetry between depth and texture view components. Thus, asymmetric depth and texture component resolutions can be processed using a MPU that may decrease latency and power consumption relative to using a MPU that requires upsampling and downsampling.

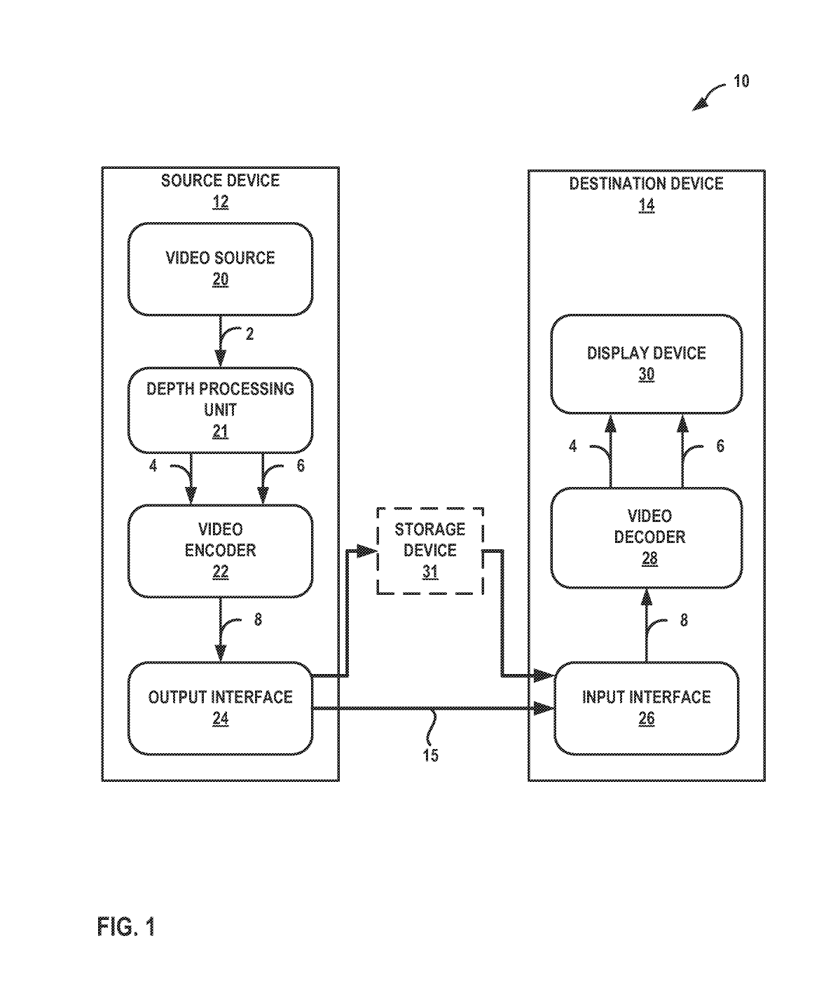

FIG. 1 is a block diagram illustrating one example of a video encoding and decoding system 10, according to techniques of the present disclosure. As shown in the example of FIG. 1, system 10 includes a source device 12 that transmits encoded video to a destination device 14 via a link 15. Link 15 can include various types of media and/or devices capable of moving the encoded video data from source device 12 to destination device 14. In one example, link 15 includes a communication medium to enable source device 12 to transmit encoded video data directly to destination device 14 in real-time. The encoded video data may be modulated according to a communication standard, such as a wireless communication protocol, and transmitted to destination device 14. The communication medium can include any wireless or wired medium, such as a radio frequency (RF) spectrum or physical transmission lines. Additionally, the communication medium can form part of a packet-based network, such as a local area network, a wide-area network, or a global network such as the Internet. Link 15 can include routers, switches, base stations, or any other equipment that may be useful to facilitate communication from source device 12 to destination device 14.

Source device 12 and destination device 14 can be a wide range of types of devices, including, e.g., wireless communication devices, such as wireless handsets, so-called cellular or satellite radiotelephones, or any wireless devices that can communicate video information over link 15, in which case link 15 is wireless. Examples according to this disclosure, which relate to coding or otherwise processing blocks of video data used in multi-view videos, can also be useful in a wide range of other settings and devices, including devices that communicate via physical wires, optical fibers or other physical or wireless media.

The disclosed examples can also be applied in a standalone device that does not necessarily communicate with any other device. For example, video decoder 28 may reside in a digital media player or other device and receive encoded video data via streaming, download or storage media. Hence, the depiction of source device 12 and destination device 14 in communication with one another is provided for purposes of illustration of an example implementation.

In some cases, devices 12 and 16 may operate in a substantially symmetrical manner, such that each of devices 12 and 16 include video encoding and decoding components. Hence, system 10 may support one-way or two-way video transmission between video devices 12 and 16, e.g., for video streaming, video playback, video broadcasting, or video telephony.

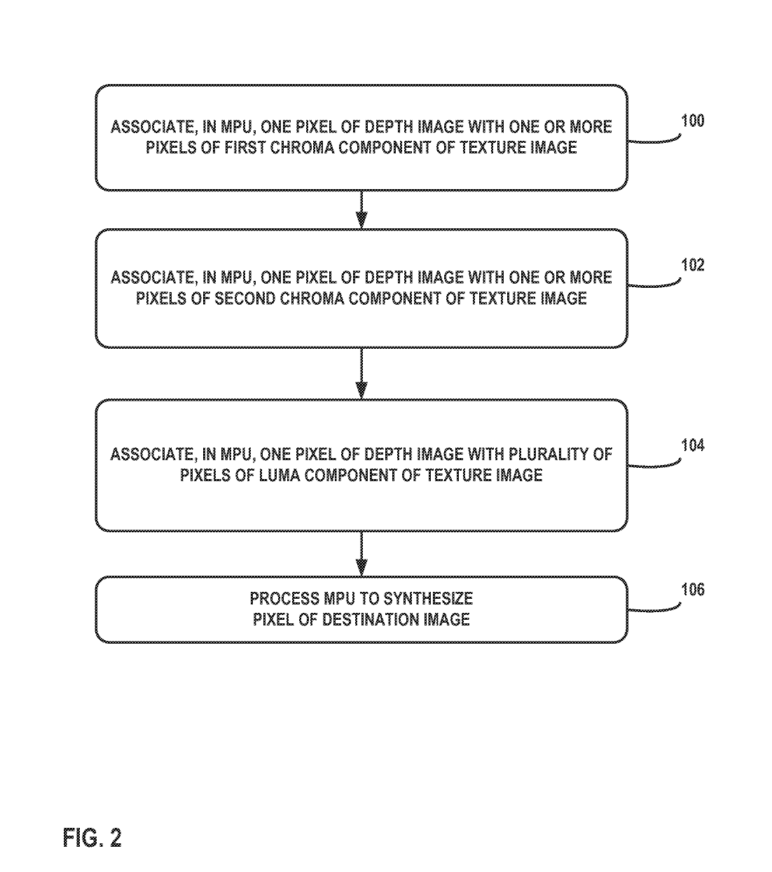

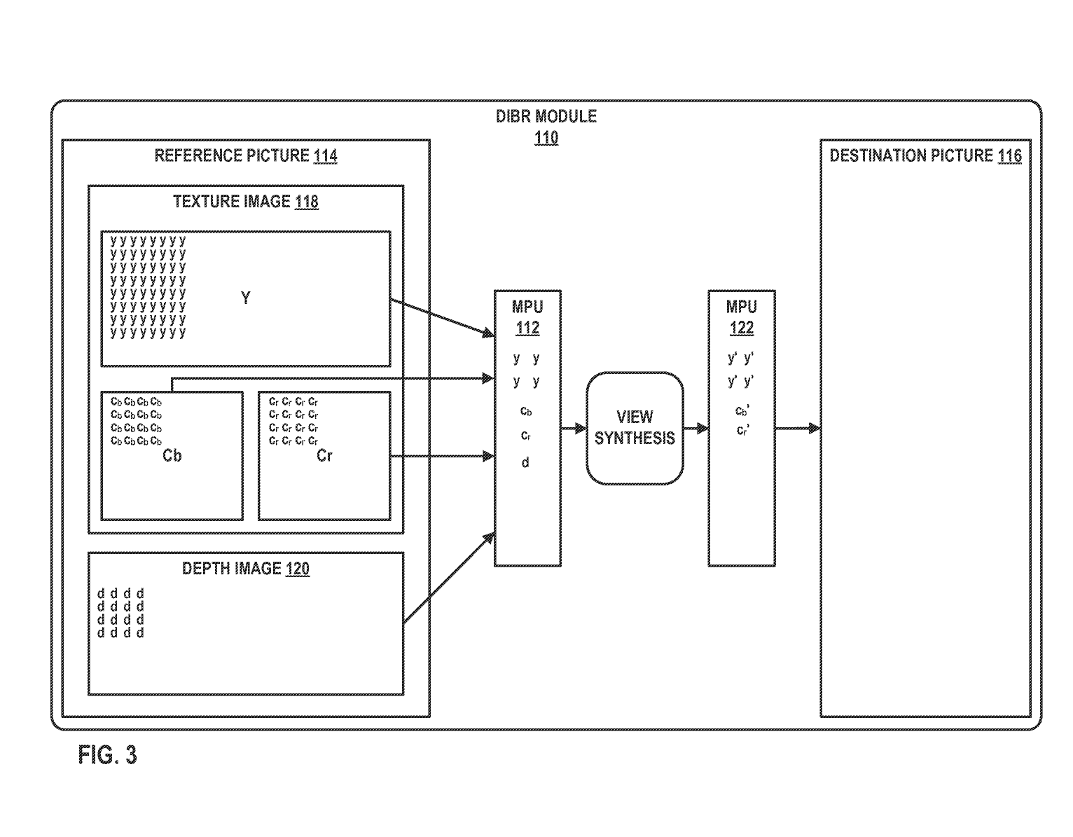

In the example of FIG. 1, source device 12 includes a video source 20, depth processing unit 21, video encoder 22, and output interface 24. Destination device 14 includes an input interface 26, video decoder 28, and display device 30. Video encoder 22 or another component of source device 12 can be configured to apply one or more of the techniques of this disclosure as part of a video encoding or other process. Similarly, video decoder 28 or another component of destination device 14 can be configured to apply one or more of the techniques of this disclosure as part of a video decoding or other process. As will be described in more detail with reference to FIGS. 2 and 3, for example, video encoder 22 or another component of source device 12 or video decoder 28 or another component of destination device 14 can include a Depth-Image-Based Rendering (DIBR) module that is configured to synthesize a destination view (or portion thereof) based on a reference view (or portion thereof) with asymmetrical resolutions of texture and depth information by processing a minimum processing unit of the reference view including different numbers of luma, chroma, and depth pixel values.

One advantage of examples according to this disclosure is that one depth pixel can correspond to one and only one MPU, instead of processing pixel by pixel where a the same depth pixel can correspond to and be processed with multiple upsampled or downsampled approximations of luma and chroma pixels in multiple MPUs. In some examples according to this disclosure, multiple luma pixels and one or multiple chroma pixels are associated in one MPU with only one and only one depth value, and the luma and chroma pixels are therefore processed jointly depending on the same logic. Thus, if, for example, based on a depth value, e.g., one depth pixel, an MPU is warped to a destination picture in a different view, multiple luma samples, and one or multiple chroma samples for each chroma component of the MPU can be warped simultaneously into the destination picture, with a relatively fixed coordination to the corresponding color components. Additionally, in the context of hole-filling, if a number of continuous holes in a row of pixels of the destination picture are detected, hole-filling in accordance with this disclosure can be done simultaneously for multiple rows of luma samples and multiple rows for chroma samples. In this manner, condition checks during both warping and hole-filling processes employed as part of view synthesis in accordance with this disclosure can be greatly decreased.

Some of the disclosed examples are described with reference to multi-view video rendering, in which new views of a multi-view video can be synthesized from existing views using decoded video data from the existing views including texture and depth view data. However, examples according to this disclosure can be used for any applications that may need DIBR, including 2D to 3D video conversion, 3D video rendering and 3D video coding.

Referring again to FIG. 1, to encode the video blocks, video encoder 22 performs intra and/or inter-prediction to generate one or more prediction blocks. Video encoder 22 subtracts the prediction blocks from the original video blocks to be encoded to generate residual blocks. Thus, the residual blocks can represent pixel-by-pixel differences between the blocks being coded and the prediction blocks. Video encoder 22 can perform a transform on the residual blocks to generate blocks of transform coefficients. Following intra- and/or inter-based predictive coding and transformation techniques, video encoder 22 can quantize the transform coefficients. Following quantization, entropy coding can be performed by encoder 22 according to an entropy coding methodology.

A coded video block generated by video encoder 22 can be represented by prediction information that can be used to create or identify a predictive block, and a residual block of data that can be applied to the predictive block to recreate the original block. The prediction information can include motion vectors used to identify the predictive block of data. Using the motion vectors, video decoder 28 may be able to reconstruct the predictive blocks that were used by video encoder 22 to code the residual blocks. Thus, given a set of residual blocks and a set of motion vectors (and possibly some additional syntax), video decoder 28 can reconstruct a video frame or other block of data that was originally encoded. Inter-coding based on motion estimation and motion compensation can achieve relatively high amounts of compression without excessive data loss, because successive video frames or other types of coded units are often similar. An encoded video sequence may include blocks of residual data, motion vectors (when inter-prediction encoded), indications of intra-prediction modes for intra-prediction, and syntax elements.

Video encoder 22 may also utilize intra-prediction techniques to encode video blocks relative to neighboring video blocks of a common frame or slice or other sub-portion of a frame. In this manner, video encoder 22 spatially predicts the blocks. Video encoder 22 may be configured with a variety of intra-prediction modes, which generally correspond to various spatial prediction directions.

The foregoing inter and intra-prediction techniques can be applied to various parts of a sequence of video data including frames representing video, e.g., pictures and other data for a particular time instance in the sequence and portions of each frame, e.g., slices of a picture. In the context of MVC plus depth, or other 3DVC processes using depth information, such a sequence of video data may represent one of multiple views included in a multi-view coded video. Various inter and intra-view prediction techniques can also be applied in MVC or MVC plus depth to predict pictures or other portions of a view. Inter and intra-view prediction can include both temporal (with or without motion compensation) and spatial prediction.

As noted, video encoder 22 can apply transform, quantization, and entropy coding processes to further reduce the bit rate associated with communication of residual blocks resulting from encoding source video data provided by video source 20. Transform techniques can in include, e.g., discrete cosine transforms (DCTs) or conceptually similar processes. Alternatively, wavelet transforms, integer transforms, or other types of transforms may be used. Video encoder 22 can also quantize the transform coefficients, which generally involves a process to possibly reduce the amount of data, e.g., bits used to represent the coefficients. Entropy coding can include processes that collectively compress data for output to a bitstream. The compressed data can include, e.g., a sequence of coding modes, motion information, coded block patterns, and quantized transform coefficients. Examples of entropy coding include context adaptive variable length coding (CAVLC) and context adaptive binary arithmetic coding (CABAC).

Video source 20 of source device 12 includes a video capture device, such as a video camera, a video archive containing previously captured video, or a video feed from a video content provider. Alternatively, video source 20 may generate computer graphics-based data as the source video, or a combination of live video, archived video, and/or computer generated video. In some cases, if video source 20 is a video camera, source device 12 and destination device 14 may form so-called camera phones or video phones, or other devices configured to manipulate video data, such as tablet computing devices. In each case, the captured, pre-captured or computer-generated video may be encoded by video encoder 22. Video source 20 captures a view and provides it to depth processing unit 21.

MVC video can be represented by two or more views, which generally represent similar video content from different view perspectives. Each view of such a multi-view video includes a sequence of temporally related two-dimensional pictures, among other elements such as audio and syntax data. For MVC plus depth coding, views can include multiple components, including a texture view component and a depth view component. Texture view components may include luma and chroma components of video information. Luma components generally describe brightness, while chroma components generally describe hues of color. In some cases, additional views of a multi-view video can be derived from a reference view based on the depth view component of the reference view. Additionally, video source data, however obtained, can be used to derive depth information from which a depth view component can be created.

In the example of FIG. 1, video source 20 provides one or more views 2 to depth processing unit 21 for calculation of depth images that can be included in view 2. A depth image can be determined for objects in view 2 captured by video source 20. Depth processing unit 21 is configured to automatically calculate depth values for objects in pictures included in view 2. For example, depth processing unit 21 calculates depth values for objects based on luma information included in view 2. In some examples, depth processing unit 21 is configured to receive depth information from a user. In some examples, video source 20 captures two views of a scene at different perspectives, and then calculates depth information for objects in the scene based on disparity between the objects in the two views. In various examples, video source 20 includes a standard two-dimensional camera, a two-camera system that provides a stereoscopic view of a scene, a camera array that captures multiple views of the scene, or a camera that captures one view plus depth information.

Depth processing unit 21 provides texture view components 4 and depth view components 6 to video encoder 22. Depth processing unit 21 may also provide view 2 directly to video encoder 22. Depth information included in depth view component 6 can include a depth map image for view 2. A depth map image may include a map of depth values for each region of pixels associated with an area (e.g., block, slice, or picture) to be displayed. A region of pixels includes a single pixel or a group of one or more pixels. Some examples of depth maps have one depth component per pixel. In other examples, there are multiple depth components per pixel. In other examples, there are multiple pixels per depth view component. Depth maps may be coded in a fashion substantially similar to texture data, e.g., using intra-prediction or inter-prediction relative to other, previously coded depth data. In other examples, depth maps are coded in a different fashion than the texture data is coded.

The depth map may be estimated in some examples. When more than one view is present, stereo matching can be used to estimate depth maps. However, in 2D to 3D conversion, estimating depth may be more difficult. Nevertheless, a depth map estimated by various methods may be used for 3D rendering based on DIBR. Although video source 20 may provide multiple views of a scene and depth processing unit 21 may calculate depth information based on the multiple views, source device 12 may generally transmit one texture component plus depth information for each view of a scene.

When view 2 is still image data, video encoder 22 may be configured to encode view 2 as, for example, a Joint Photographic Experts Group (JPEG) image. When view 2 is a frame of video data, video encoder 22 is configured to encode first view 50 according to a video coding standard such as, for example Motion Picture Experts Group (MPEG), International Organization for Standardization (ISO)/International Electrotechnical Commission (IEC) MPEG-1 Visual, ISO/IEC MPEG-2 Visual, ISO/IEC MPEG-4 Visual, International Telecommunication Union (ITU) H.261, ITU-T H.262, ITU-T H.263, ITU-T H.264/MPEG-4, H.264 Advanced Video Coding (AVC), the upcoming High Efficiency Video Coding (HEVC) standard (also referred to as H.265), or other video encoding standards. Video encoder 22 may include depth information of depth view component 6 along with texture information of texture view component 4 to form coded block 8.

Video encoder 22 can include a DIBR module or functional equivalent that is configured to synthesize a destination view based on a reference view with asymmetrical resolutions of texture and depth information by processing a minimum processing unit of the reference view including different numbers of luma, chroma, and depth pixel values. For example, video source 20 of source device 12 may only provide one view 2 to depth processing unit 21, which, in turn, may only provide one set of texture view component 4 and depth view component 6 to encoder 22. However, it may be desirable or necessary, to synthesize additional views and encode the views for transmission. As such, video encoder 22 can be configured to synthesize a destination view based on texture view component 4 and depth view component 6 of reference view 2. Video encoder 22 can be configured to synthesize the new view even if view 2 includes asymmetrical resolutions of texture and depth information by processing a minimum processing unit of reference view 2 including different numbers of luma, chroma, and depth pixel values.

Video encoder 22 passes coded block 8 to output interface 24 via link 15 or stores block 8 at storage device 31. For example, coded block 8 can be transferred to input interface 26 of destination device 14 in a bitstream including signaling information along with coded block 8 over link 15. In some examples, source device 12 may include a modem that modulates coded block 8 according to a communication standard. A modem may include various mixers, filters, amplifiers or other components designed for signal modulation. Output interface 24 may include circuits designed for transmitting data, including amplifiers, filters, and one or more antennas. In some examples, rather than transmitting over a communication channel, e.g., over link 15, source device 12 stores encoded video data, including blocks having texture and depth components, onto a storage device 31, such as a digital video disc (DVD), Blu-ray disc, flash drive, or the like.

In destination device 14, video decoder 28 receives encoded video data 8. For example, input interface 26 of destination device 14 receives information over link 15 or from storage device 31 and video decoder 28 receives video data 8 received at input interface 26. In some examples, destination device 14 includes a modem that demodulates the information. Like output interface 24, input interface 26 may include circuits designed for receiving data, including amplifiers, filters, and one or more antennas. In some instances, output interface 24 and/or input interface 26 may be incorporated within a single transceiver component that includes both receive and transmit circuitry. A modem may include various mixers, filters, amplifiers or other components designed for signal demodulation. In some instances, a modem may include components for performing both modulation and demodulation.

In one example, video decoder 28 entropy decodes the received encoded video data 8, such as a coded block, according to an entropy coding methodology, such as CAVLC or CABAC, to obtain the quantized coefficients. Video decoder 28 applies inverse quantization (de-quantization) and inverse transform functions to reconstruct the residual block in the pixel domain. Video decoder 28 also generates a prediction block based on control information or syntax information (e.g., coding mode, motion vectors, syntax that defines filter coefficients and the like) included in the encoded video data. Video decoder 28 calculates a sum of the prediction block and the reconstructed residual block to produce a reconstructed video block for display.

Display device 30 displays the decoded video data to a user including, e.g., multi-view video including destination view(s) synthesized based on depth information included in a reference view or views. Display device 30 can include any of a variety of one or more display devices such as a cathode ray tube (CRT), a liquid crystal display (LCD), a plasma display, an organic light emitting diode (OLED) display, or another type of display device. In some examples, display device 30 corresponds to a device capable of three-dimensional playback. For example, display device 30 may include a stereoscopic display, which is used in conjunction with eyewear worn by a viewer. The eyewear may include active glasses, in which case display device 30 rapidly alternates between images of different views synchronously with alternate shuttering of lenses of the active glasses. Alternatively, the eyewear may include passive glasses, in which case display device 30 displays images from different views simultaneously, and the passive glasses may include polarized lenses that are generally polarized in orthogonal directions to filter between the different views.

Video encoder 22 and video decoder 28 may operate according to a video compression standard, such as the ITU-T H.264 standard, alternatively described as MPEG 4, Part 10, Advanced Video Coding (AVC), or the HEVC standard. More particularly, the techniques may be applied, as examples, in processes formulated according to the MVC+D 3DVC extension to H.264/AVC, the 3D-AVC extension to H.264/AVC, the MVC-HEVC extension, the 3D-HEVC extension, or the like, or other standards where DIBR may be useful. The techniques of this disclosure, however, are not limited to any particular video coding standard.

In some cases, video encoder 22 and video decoder 28 may each be integrated with an audio encoder and decoder, and may include appropriate MUX-DEMUX units, or other hardware and software, to handle encoding of both audio and video in a common data stream or separate data streams. If applicable, MUX-DEMUX units may conform to the ITU H.223 multiplexer protocol, or other protocols such as the user datagram protocol (UDP).

Video encoder 22 and video decoder 28 each may be implemented as one or more microprocessors, digital signal processors (DSPs), application specific integrated circuits (ASICs), field programmable gate arrays (FPGAs), discrete logic, software, hardware, firmware or any combinations thereof. When any or all of the techniques of this disclosure are implemented in software, an implementing device may further include hardware for storing and/or executing instructions for the software, e.g., a memory for storing the instructions and one or more processing units for executing the instructions. Each of video encoder 22 and video decoder 28 may be included in one or more encoders or decoders, either of which may be integrated as part of a combined codec that provides encoding and decoding capabilities in a respective mobile device, subscriber device, broadcast device, server, or other types of devices.

A video sequence typically includes a series of video frames, also referred to as video pictures. Video encoder 22 operates on video blocks within individual video frames in order to encode the video data, e.g., coded block 8. The video blocks may have fixed or varying sizes, and may differ in size according to a specified coding standard. Each video frame can be sub-divided into a number of slices. In the ITU-T H.264 standard, for example, each slice includes a series of macroblocks, which may each also be divided into sub-blocks. The H.264 standard supports intra-prediction in various block sizes for two dimensional (2D) video encoding, such as 16 by 16, 8 by 8, or 4 by 4 for luma components, and 8 by 8 for chroma components, as well as inter prediction in various block sizes, such as 16 by 16, 16 by 8, 8 by 16, 8 by 8, 8 by 4, 4 by 8 and 4 by 4 for luma components and corresponding scaled sizes for chroma components. Video blocks may include blocks of pixel data, or blocks of transformation coefficients, e.g., following a transformation process such as discrete cosine transform (DCT) or a conceptually similar transformation process. Block-based processing using such block size configurations can be extended to 3D video.

Smaller video blocks can provide better resolution, and may be used for locations of a video frame that include high levels of detail. In general, macroblocks and the various sub-blocks may be considered to be video blocks. In addition, a slice may be considered to be a series of video blocks, such as macroblocks and/or sub-blocks. Each slice may be an independently decodable unit of a video frame. Alternatively, frames themselves may be decodable units, or other portions of a frame may be defined as decodable units. The 2D macroblocks of the ITU-T H.264 standard may be extended to 3D by, e.g., encoding depth information from a depth map together with associated luma and chroma components (that is, texture components) for that video frame or slice. In some examples, depth information is coded as monochromatic video.

In principle, video data can be sub-divided into any size blocks. Thus, although particular macroblock and sub-block sizes according to the ITU-T H.264 standard are described above, other sizes can be employed to code or otherwise process video data. For example, video block sizes in accordance with the upcoming High Efficiency Video Coding (HEVC) standard can be employed to code video data. The standardization efforts for HEVC are based in part on a model of a video coding device referred to as the HEVC Test Model (HM). The HM presumes several capabilities of video coding devices over devices according to, e.g., ITU-T H.264/AVC. For example, whereas H.264 provides nine intra-prediction encoding modes, HM provides as many as thirty-three intra-prediction encoding modes. HEVC may be extended to support the techniques as described herein.

In addition to inter and intra-prediction techniques employed as part of a 2D video coding or MVC process, new views of a multi-view video can be synthesized from existing views using decoded video data from the existing views including texture and depth view data. View synthesis can include a number of different processes, including, e.g., warping and hole-filling. As noted above, view synthesis may be executed as part of a DIBR process to synthesize one or more destination views from a reference view based on the depth view component of the reference view. In accordance with this disclosure, view synthesis or other processing of multi-view video data is executed based on reference view data with asymmetrical resolutions of texture and depth information by processing an MPU of the reference view including different numbers of luma, chroma, and depth pixel values. Such view synthesis or other processing of MPUs of a reference view including different numbers of luma, chroma, and depth pixel values can be executed without upsampling and downsampling the texture and depth components of different resolutions.

A reference view, e.g., one of views 2 that can form part of a multi-view video can include a texture view component and a depth view component. At the individual picture level, a reference picture that forms part of the reference view can include a texture image and depth image. The depth image includes information that can be used by a decoder or other device to synthesize the destination picture from the reference picturing including the texture image and the depth image. As described in more detail below, in some cases, synthesizing a destination picture from a reference picture includes “warping” the pixels of the texture image using the depth information from the depth image to determine the pixels of the destination picture.

In some cases, the synthesis of a destination picture of a destination view from a reference picture of a reference view can include processing of multiple pixel values from the reference picture, including, e.g., luma, chroma, and depth pixel values. Such a set of pixel values from which a portion of the destination picture is synthesized is sometimes referred to as a minimum processing unit, or, “MPU.” In some cases, the resolution of the luma and chroma, and the depth view components of a reference view may not be the same.

Examples according to this disclosure perform view synthesis on an MPU. However, to support asymmetric resolutions for the depth and texture view components, the MPU may not necessarily require association of only one pixel from each of the luma, chroma, and depth view components. Rather, a device, e.g., source device 12, destination device 14, or another device can associate one depth value with multiple luma values and one or more chroma values, and more particularly, the device can associate different numbers of luma values and chroma values with the depth value. In other words, the number of pixels in the luma component that are associated with one pixel of the depth view component, and the number of pixels in the chroma component that are associated with one pixel in the depth view component, can be different. In this manner, examples according to this disclosure can execute view synthesis or other processing of MPUs of a reference view including different numbers of luma, chroma, and depth pixel values without upsampling and downsampling the texture and depth components.

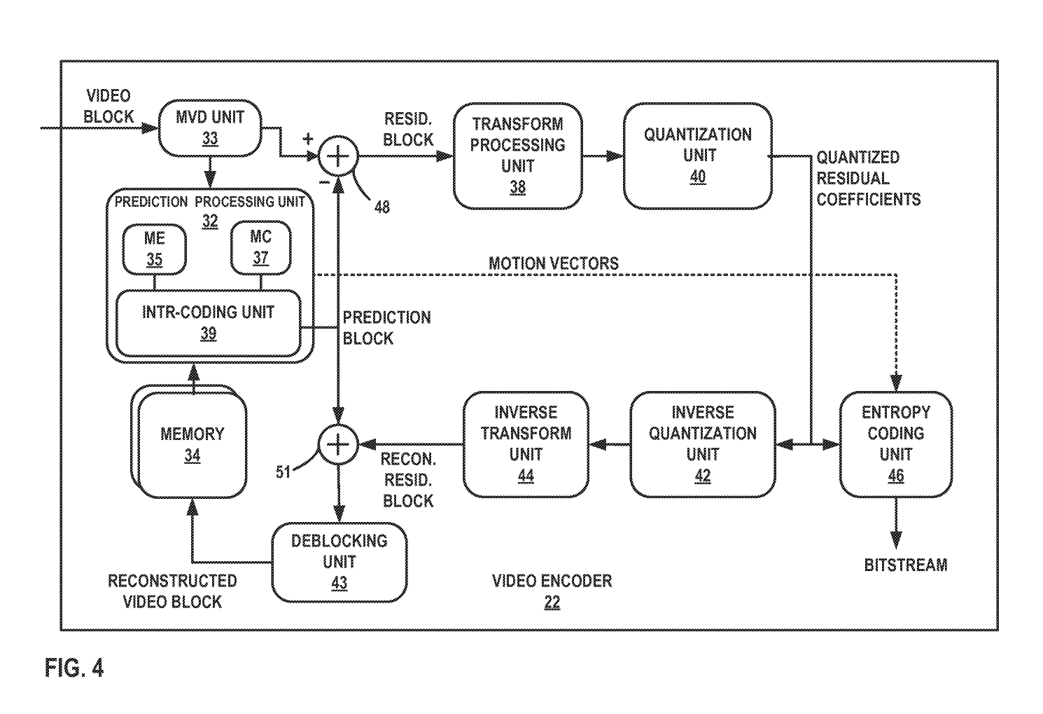

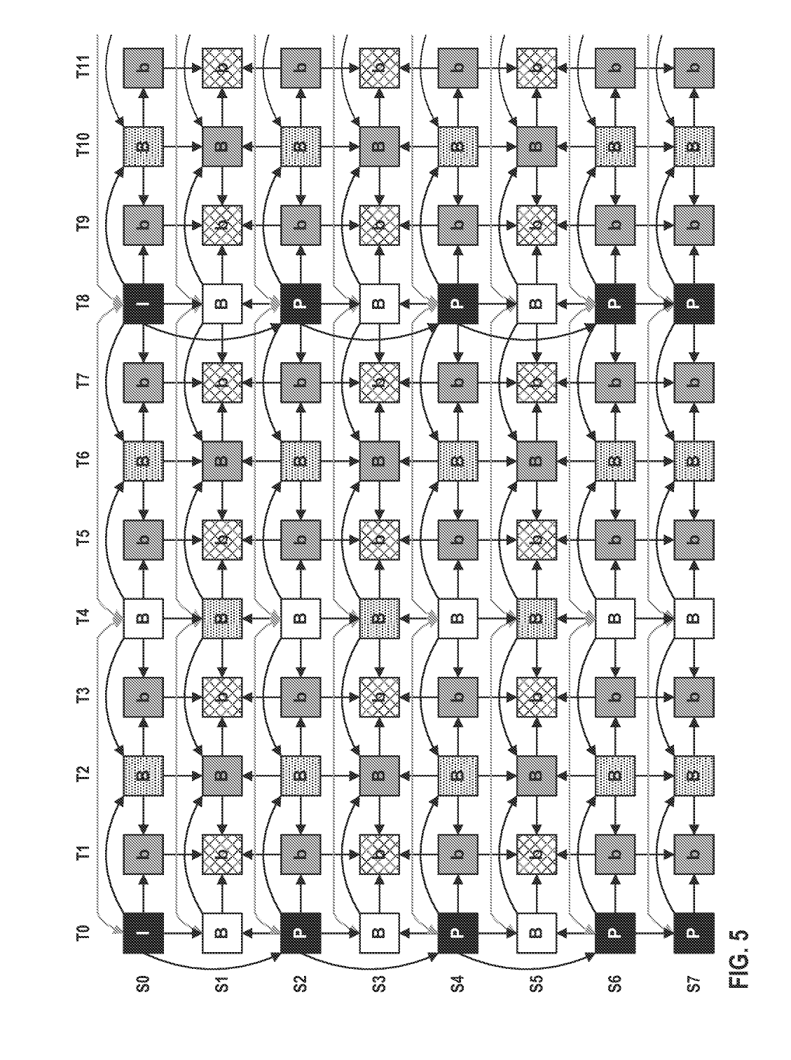

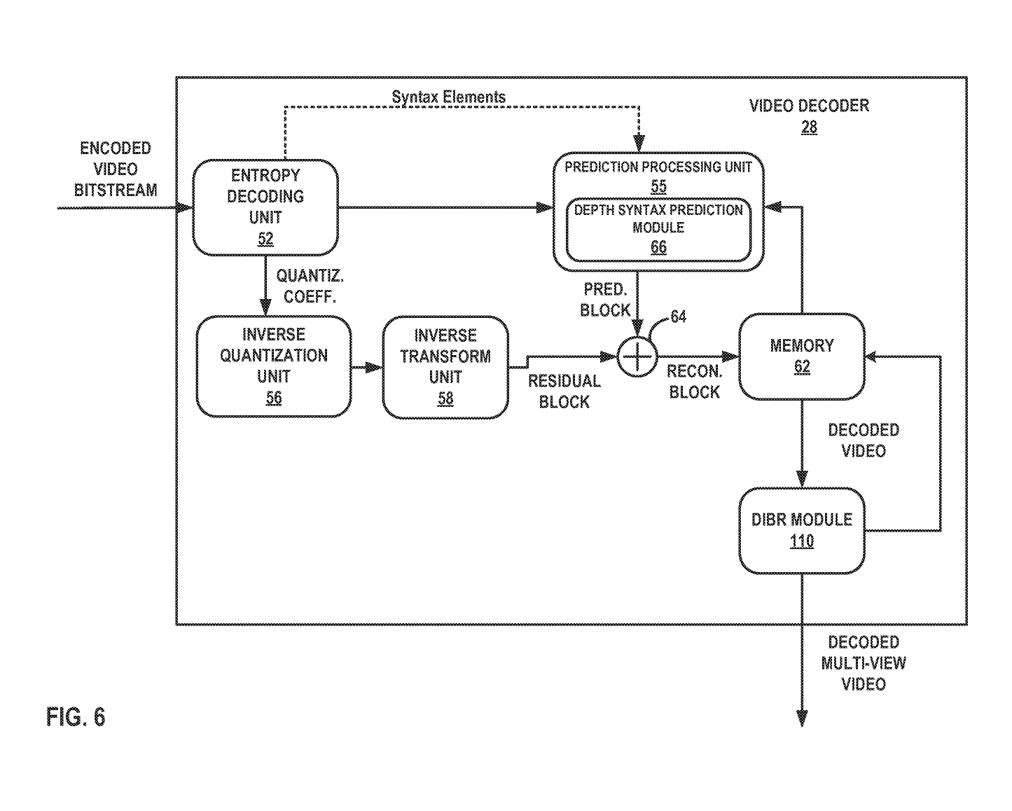

Additional details regarding the association, in an MPU, of different numbers of luma, chroma, and depth pixel values and view synthesis based on such an MPU are described below with reference to FIGS. 2 and 3. Particular techniques that may be used for view synthesis, including, e.g., warping and hole-filling are also described with reference to FIGS. 2 and 3. The components of an example encoder and decoder device are described with reference to FIGS. 4 and 6 and an example multi-view coding process is illustrated in and described with reference to FIG. 5. Some of the following examples describe the association of pixel values in an MPU and view synthesis as executed by a decoder device including a DIBR module in the context of rendering multi-view video for viewing. However, in other examples, other devices and/or module/functional configurations could be used, including, associating pixel values in an MPU and executing view synthesis at an encoder as part of an MVC plus depth process or at a device/component separate from an encoder and decoder.

FIG. 2 is a flowchart illustrating an example method including associating, in an MPU, one, e.g., a single pixel of a depth image of a reference picture with one or, in some cases, more than one pixel of a first chroma component of a texture image of the reference picture (100). The MPU indicates an association of pixels needed to synthesize a pixel in a destination picture. The destination picture and the texture component of the reference picture when viewed together form a three-dimensional picture. The method of FIG. 2 also includes associating, in the MPU, the one pixel of the depth image with one or, in some cases, more than one pixel of a second chroma component of the texture image (102), associating, in the MPU, the one pixel of the depth image with a plurality of pixels of a luma component of the texture image (104). The number of the pixels of the luma component is different than the number of pixels of the first chroma component and the number of pixels of the second chroma component. For example, the number of pixels of the luma component may be greater than the number of pixels of the first chroma component, and greater than the number of pixels of the second chroma component. The method of FIG. 2 also includes processing the MPU to synthesize a pixel of the destination picture (106).

The functions of this method may be executed in a number of different ways by devices including different physical and logical structures. In one example, the example method of FIG. 2 is carried out by DIBR module 110 illustrated in the block diagram of FIG. 3. DIBR module 110 or another functional equivalent could be included in different types of devices. In the following examples, DIBR module 110 is described as implemented on a video decoder device, for purposes of illustration.

DIBR module 110 can be implemented as one or more microprocessors, digital signal processors (DSPs), application specific integrated circuits (ASICs), field programmable gate arrays (FPGAs), discrete logic, software, hardware, firmware or any combinations thereof. When any or all of the techniques of this disclosure are implemented in software, an implementing device may further include hardware for storing and/or executing instructions for the software, e.g., a memory for storing the instructions and one or more processing units for executing the instructions.

In one example, DIBR module 110 associates, in an MPU, different numbers of luma, chroma, and depth pixels in accordance with the example method of FIG. 2. As described above, the synthesis of a destination picture can include processing of multiple pixel values from the reference picture, including, e.g., luma, chroma, and depth pixel values. Such a set of pixel values from which a portion of the destination picture is synthesized is sometimes referred to as MPU.

In the example of FIG. 3, DIBR module 110 associates luma, chroma, and depth pixel values in MPU 112. The pixel values associated in MPU 112 form part of the video data of reference picture 114, from which DIBR module 110 is configured to synthesize destination picture 116. Reference picture 114 may be video data associated with one time instance of a view of a multi-view video. Destination picture 116 may be corresponding video data associated with the same time instance of a destination view of the multi-view video. Reference picture 114 and destination picture 116 can each be 2D images that, when viewed together, produce one 3D image in a sequence of such sets of images in a 3D video.

Reference picture 114 includes texture image 118 and depth image 120. Texture image 118 includes one luma component, Y, and two chroma components, Cb and Cr. Texture image 118 of reference picture 114 may be represented by a number of pixel values defining the color of pixel locations of the image. In particular, each pixel location of texture image 118 can be defined by one luma pixel value, y, and two chroma pixel values, c_{b} and cᵣ, as illustrated in FIG. 2. Depth image 120 includes a number of pixel values, d, associated with different pixel positions of the image, which define depth information for corresponding pixels of reference picture 114. The pixel values of depth image 120 may be employed by DIBR module 110 to synthesize pixel values of destination image 116, e.g., by warping and/or hole-filling processes described in more detail below.

In the example of FIG. 3, the two chroma components, Cb and Cr, of texture image 118 and the depth component represented by depth image 120 are at one quarter the resolution of the luma component, Y, of texture image 118. Thus, in this example, for every one depth pixel, d, one pixel of the first chroma component, c_{b}, and one pixel of the second chroma component, cᵣ, there are four pixels of the luma component, yyyy.

In order to process pixels of reference picture 114 in a single MPU without the need to upsample and downsample different components of the picture (e.g., upsample/downsample chroma pixel, c_{b} and cᵣ, and depth pixels, d), DIBR module 110 is configured to associate, in MPU 112, a single depth pixel, d, with a single pixel of the first chroma component, c_{b}, and a single pixel of the second chroma component, cᵣ, and four pixels of the luma component, yyyy, as illustrated in FIG. 3.

It is noted that, although some of the disclosed examples refer to depth and chroma components at the same resolution, other examples of asymmetric resolution are also included. For example, the depth component may have even a lower resolution than that of the chroma components. In one example, the depth image includes a resolution of 180×120, the luma component of the texture image is at a resolution 720×480, and the chroma components are each at a resolution of 360×240. In this case, an MPU in accordance with this disclosure could associate 4 chroma pixels for each chroma component and 16 luma pixels for each luma component and the warping of all pixels in one MPU could be controlled together by one depth image pixel.

Referring again to FIG. 3, after associating, in MPU 112, one depth pixel, d, with one pixel of the first chroma component, c_{b}, and one pixel of the second chroma component, cᵣ, and four pixels of the luma component, yyyy, DIBR module 110 can be configured to synthesize a portion of destination picture 116 from the MPU. In one example, DIBR module 110 is configured to execute one or more processes to warp one MPU of reference picture 114 to one MPU of destination picture 116 and can also implement a hole-filling process to fill pixel locations in destination image that do not include pixel values after warping.

In some examples, given image depth and a camera model from which source image data is captured, DIBR module 110 can “warp” a pixel of reference picture 114 by first projecting the pixel from a coordinate of a planar 2D coordinate system to a coordinate in 3D coordinate system. The camera model can include a computational scheme that defines relationships between a 3D point and its projection onto an image plane, which may be used for this first projection. DIBR module 110 can then project the point to a pixel location in destination picture 116 along the direction of a view angle associated with destination picture. The view angle can represent, e.g., the point of observation of a viewer.

One method of warping is based on a disparity value. In one example, a disparity value can be calculated by DIBR module 110 for each texture pixel associated with a given depth value in reference picture 114. The disparity value can represent or define the number of pixels a given pixel in reference picture 114 will be spatially offset to produce destination picture 116 that, when viewed with reference picture 114, produces a 3D image. The disparity value can include a displacement in the horizontal, vertical, or horizontal and vertical directions. In one example, therefore, a pixel in texture image 118 of reference picture 114 can be warped to a pixel in destination picture 116 by DIBR module 110 based on a disparity value determined based on or defined by a pixel in depth image 120 of reference picture 114.

In one example including stereoscopic 3D video, DIBR module 110 utilizes the depth information from depth image 120 of reference picture 114 to determine by how much to horizontally displace a pixel in texture image 118 (e.g., a first view such as a left eye view) to synthesize a pixel in reference picture 114 (e.g., a second view such as a right eye view). Based on the determination, DIBR module 110 can place the pixel in the synthesized destination picture 116, which ultimately can form a portion of one view in the 3D video. For example, if a pixel is located at pixel location (x0, y0) in texture image 118 of reference picture 114, DIBR module 110 can determine that the pixel should be placed at pixel location (x0′, y0) in destination picture 116 based on the depth information provided by depth image 120 that corresponds to the pixel located at (x0, y0) in texture image 118 of reference picture 114.

In the example of FIG. 3, DIBR module 110 can warp the texture pixels of MPU 112, yyyy, c_{b}, cᵣ, based on the depth information provided by the depth pixel, d, to synthesize MPU 122 of destination picture. MPU 122 includes four warped luma pixels y′y′y′y′, and one of each chroma component c_{b}′, cᵣ′, i.e., a single c_{b}′ component and a single cᵣ′ component. Thus, the single depth pixel, d, is employed by DIBR module 110 to warp four luma pixels, and one chroma pixel for each chroma component simultaneously into destination picture 116. As noted above, condition checks during both warping processes employed by DIBR module 110 may thereby be decreased.

In some cases, multiple pixels from the reference picture are mapped to the same location of the destination picture. The result can be one or more pixel locations in the destination picture that do not include any pixel values after warping. In the context of the previous example, it is possible that DIBR module 110 warps the pixel located at (x0, y0) in texture image 118 of reference picture 114 to a pixel located at (x0′, y0) in destination picture 116. Additionally, DIBR module 110 warps a pixel located at (x1, y0) in texture image 118 of reference picture 114 to a pixel at the same position (x0′, y0) in destination picture 116. This may result in there being no pixel located at (x1′, y0) destination picture 116, i.e., there is a hole at (x1′, y0).

In order to address such “holes” in the destination picture, DIBR module 110 can execute a hole-filling process by which techniques analogous to some spatial intra-prediction coding techniques are employed to fill the holes in the destination picture with appropriate pixel values. For example, DIBR module 110 can utilize the pixel values for one or more pixels neighboring the pixel location (x1′, y0) to fill the hole at (x1′, y0). DIBR module 110 can, in one example, analyze a number of pixels neighboring the pixel location (x1′, y0) to determine which, if any, of the pixels include values appropriate to fill the hole at (x1′, y0). In one example, DIBR module 110 can iteratively fill the hole at (x1′, y0) different pixel values of different neighboring pixels. DIBR module 110 can then analyze a region of destination picture 116 including the filled hole at (x1′, y0) to determine which of the pixel values produces the best image quality.

The foregoing or another hole-filling process can be executed by DIBR module 110 row-by-row of pixels in destination picture 116. DIBR module 110 can fill one or multiple MPUs of destination picture 116 based on MPU 112 of texture image 118 of reference picture 114. In one example, DIBR module 110 can simultaneously fill multiple MPUs of destination picture 116 based on MPU 112 of texture image 118. In such an example, hole-filling executed by DIBR module 110 can provide pixel values for multiple rows of a luma component, and first and second chroma components of destination picture 116. As the MPU contains multiple luma samples, one hole in the destination picture may include multiple luma pixels. Hole-filling can be based on the neighboring non-hole pixels. For example, the left non-hole pixel and the right non-hole pixel of a hole are examined and the one with a depth value corresponding to a farther distance is used to set the value of the hole. In another example, the holes may be filled by interpolation from the nearby non-hole pixels.

DIBR module 110 can iteratively associate, in an MPU, pixel values from reference picture 114 and process the MPUs to synthesize destination picture 116. Destination picture 116 can thus be generated such that, when viewed together with reference picture 114, the two pictures of two views produce one 3D image in a sequence of such sets of images in a 3D video. DIBR module 110 can iteratively repeat this process on multiple reference pictures to synthesize multiple destination pictures to synthesize a reference view that, when viewed together with the reference view, the two views produce a 3D. DIBR module 110 can synthesize multiple destination views based on one or more reference views to produce a multi-view video including more than two views.

In the foregoing or another manner, DIBR module 110 or another device can be configured to synthesize destination views or otherwise process video data of a reference view of a multi-view video based on an association, in an MPU, of different numbers luma, chroma, and depth values of the reference view. Although FIG. 3 contemplates an example including depth and chroma components of a reference picture at one quarter the resolution of the luma component of the reference picture, examples according to this disclosure may be applied to other asymmetrical resolutions. In general, the disclosed examples may be employed to associate, in an MPU, one depth pixel, d, with one or multiple chroma pixels, c, of each of the first and second chroma components, Cb and Cr, of the texture picture, and multiple pixels, y, of the luma component, Y, of the texture picture.

For example, two chroma components, Cb and Cr, of a texture image and the depth component represented by the depth image could be at one half the resolution of the luma component, Y, of the texture image. In this example, for every one depth pixel, d, one pixel of the first chroma component, c_{b}, and one pixel of the second chroma component, cᵣ, there are two pixels of the luma component, yy.

In order to process pixels of the reference picture in a single MPU without the need to upsample and downsample different components of the picture, a DIBR module or another component can be configured to associate, in the MPU, one depth pixel, d, with one pixel of the first chroma component, c_{b}, and one pixel of the second chroma component, cᵣ, and two pixels of the luma component, yy.

After associating, in the MPU 112, the one depth pixel, d, with the one pixel of the first chroma component, c_{b}, the one pixel of the second chroma component, cᵣ, and the two pixels of the luma component, yy, the DIBR module can be configured to synthesize a portion of a destination picture from the MPU. In one example, the DIBR module 110 is configured to warp the MPU of the reference picture to one MPU of the destination picture and can also fill holes in the destination image at pixel locations that do not include pixel values after warping in a manner similar to that described above with reference to the one quarter resolution example of FIG. 3.

FIG. 4 is a block diagram illustrating an example of video encoder 22 of FIG. 1 in further detail. Video encoder 22 is one example of a specialized video computer device or apparatus referred to herein as a “coder.” As shown in FIG. 4, video encoder 22 corresponds to video encoder 22 of source device 12. However, in other examples, video encoder 22 may correspond to a different device. In further examples, other units (such as, for example, other encoder/decoder (CODECS)) can also perform similar techniques to those performed by video encoder 22.

In some cases, video encoder 22 can include a DIBR module or other functional equivalent that is configured to synthesize a destination view based on a reference view with asymmetrical resolutions of texture and depth information by processing a minimum processing unit of the reference view including different numbers of luma, chroma, and depth pixel values. For example, a video source may only provide one or multiple views to video encoder, each of which includes texture view component and depth view component 6. However, it may be desirable or necessary, to synthesize additional views and encode the views for transmission. As such, video encoder 22 can be configured to synthesize a new destination view based on a texture view component and depth view component of an existing reference view. In accordance with this disclosure, video encoder 22 can be configured to synthesize the new view even if the reference view includes asymmetrical resolutions of texture and depth information by processing an MPU of the reference view associating one depth value with multiple luma values, and one or multiple chroma values for each chroma component.

Video encoder 22 may perform at least one of intra- and inter-coding of blocks within video frames, although intra-coding components are not shown in FIG. 2 for ease of illustration. Intra coding relies on spatial prediction to reduce or remove spatial redundancy in video within a given video frame. Inter-coding relies on temporal prediction to reduce or remove temporal redundancy in video within adjacent frames of a video sequence. Intra-mode (I-mode) may refer to the spatial-based compression mode. Inter-modes such as a prediction (P-mode) or a bi-directional (B-mode) may refer to the temporal based compression modes.

As shown in FIG. 2, video encoder 22 receives a video block within a video frame to be encoded. In one example, video encoder 22 receives texture view components 4 and depth view components 6. In another example, video encoder receives view 2 from video source 20.

In the example of FIG. 4, video encoder 22 includes a prediction processing unit 32, motion estimation (ME) unit 35, motion compensation (MC) unit (MCU), multi-view video plus depth (MVD) unit 33, memory 34, an intra-coding unit 39, a first adder 48, a transform processing unit 38, a quantization unit 40, and an entropy coding unit 46. For video block reconstruction, video encoder 22 also includes an inverse quantization unit 42, an inverse transform processing unit 44, a second adder 51, and a deblocking unit 43. Deblocking unit 43 is a deblocking filter that filters block boundaries to remove blockiness artifacts from reconstructed video. If included in video encoder 22, deblocking unit 43 would typically filter the output of second adder 51. Deblocking unit 43 may determine deblocking information for the one or more texture view components. Deblocking unit 43 may also determine deblocking information for the depth map component. In some examples, the deblocking information for the one or more texture components may be different than the deblocking information for the depth map component. In one example, as shown in FIG. 4, transform processing unit 38 represents a functional block, as opposed to a “TU” in terms of HEVC.

Multi-view video plus depth (MVD) unit 33 receives one or more video blocks (labeled “VIDEO BLOCK” in FIG. 2) comprising texture components and depth information, such as texture view components 4 and depth view components 6. MVD unit 33 provides functionality to video encoder 22 to encode depth components in a block unit. The MVD unit 33 may provide the texture view components and depth view components, either combined or separately, to prediction processing unit 32 in a format that enables prediction processing unit 32 to process depth information. MVD unit 33 may also signal to transform processing unit 38 that the depth view components are included with the video block. In other examples, each unit of video encoder 22, such as prediction processing unit 32, transform processing unit 38, quantization unit 40, entropy coding unit 46, etc., comprises functionality to process depth information in addition to texture view components.

In general, video encoder 22 encodes the depth information in a manner similar to chrominance information, in that motion compensation unit 37 is configured to reuse motion vectors calculated for a luminance component of a block when calculating a predicted value for a depth component of the same block. Similarly, an intra-prediction unit of video encoder 22 may be configured to use an intra-prediction mode selected for the luminance component (that is, based on analysis of the luminance component) when encoding the depth view component using intra-prediction.

Prediction processing unit 32 includes a motion estimation (ME) unit 35 and motion compensation (MC) unit 37. Prediction processing unit 32 predicts depth information for pixel locations as well as for texture components.

During the encoding process, video encoder 22 receives a video block to be coded (labeled “VIDEO BLOCK” in FIG. 2), and prediction processing unit 32 performs inter-prediction coding to generate a prediction block (labeled “PREDICTION BLOCK” in FIG. 2). The prediction block includes both texture view components and depth view information. Specifically, ME unit 35 may perform motion estimation to identify the prediction block in memory 34, and MC unit 37 may perform motion compensation to generate the prediction block.

Alternatively, intra prediction unit 39 within prediction processing unit 32 may perform intra-predictive coding of the current video block relative to one or more neighboring blocks in the same frame or slice as the current block to be coded to provide spatial compression.

Motion estimation is typically considered the process of generating motion vectors, which estimate motion for video blocks. A motion vector, for example, may indicate the displacement of a prediction block within a prediction or reference frame (or other coded unit, e.g., slice) relative to the block to be coded within the current frame (or other coded unit). The motion vector may have full-integer or sub-integer pixel precision. For example, both a horizontal component and a vertical component of the motion vector may have respective full integer components and sub-integer components. The reference frame (or portion of the frame) may be temporally located prior to or after the video frame (or portion of the video frame) to which the current video block belongs. Motion compensation is typically considered the process of fetching or generating the prediction block from memory 34, which may include interpolating or otherwise generating the predictive data based on the motion vector determined by motion estimation.

ME unit 35 calculates at least one motion vector for the video block to be coded by comparing the video block to reference blocks of one or more reference frames (e.g., a previous and/or subsequent frame). Data for the reference frames may be stored in memory 34. ME unit 35 may perform motion estimation with fractional pixel precision, sometimes referred to as fractional pixel, fractional pel, sub-integer, or sub-pixel motion estimation. Fractional pixel motion estimation can allow prediction processing unit 32 to predict depth information at a first resolution and to predict the texture components at a second resolution.

Once prediction processing unit 32 has generated the prediction block, for example, using either inter-prediction or intra-prediction, video encoder 22 forms a residual video block (labeled “RESID. BLOCK” in FIG. 2) by subtracting the prediction block from the original video block being coded. This subtraction may occur between texture components in the original video block and texture components in the prediction block, as well as for depth information in the original video block or depth map from depth information in the prediction block. Adder 48 represents the component or components that perform this subtraction operation.

Transform processing unit 38 applies a transform, such as a discrete cosine transform (DCT) or a conceptually similar transform, to the residual block, producing a video block comprising residual transform block coefficients. It should be understood that transform processing unit 38 represents the component of video encoder 22 that applies a transform to residual coefficients of a block of video data, in contrast to a transform unit (TU) of a coding unit (CU) as defined by HEVC. Transform processing unit 38, for example, may perform other transforms, such as those defined by the H.264 standard, which are conceptually similar to DCT. Such transforms include, for example, directional transforms (such as Karhunen-Loeve theorem transforms), wavelet transforms, integer transforms, sub-band transforms, or other types of transforms. In any case, transform processing unit 38 applies the transform to the residual block, producing a block of residual transform coefficients. The transform converts the residual information from a pixel domain to a frequency domain.

Quantization unit 40 quantizes the residual transform coefficients to further reduce bit rate. The quantization process may reduce the bit depth associated with some or all of the coefficients. Quantization unit 40 may quantize a depth image coding residue. Following quantization, entropy coding unit 46 entropy codes the quantized transform coefficients. For example, entropy coding unit 46 may perform CAVLC, CABAC, or another entropy coding methodology.

Entropy coding unit 46 may also code one or more motion vectors and support information obtained from prediction processing unit 32 or other component of video encoder 22, such as quantization unit 40. The one or more prediction syntax elements may include a coding mode, data for one or more motion vectors (e.g., horizontal and vertical components, reference list identifiers, list indexes, and/or motion vector resolution signaling information), an indication of a used interpolation technique, a set of filter coefficients, an indication of the relative resolution of the depth image to the resolution of the luma component, a quantization matrix for the depth image coding residue, deblocking information for the depth image, or other information associated with the generation of the prediction block. These prediction syntax elements may be provided in the sequence level or in the picture level.

The one or more syntax elements may also include a quantization parameter (QP) difference between the luma component and the depth component. The QP difference may be signaled at the slice level and may be included in a slice header for the texture view components. Other syntax elements may also be signaled at a coded block unit level, including a coded block pattern for the depth view component, a delta QP for the depth view component, a motion vector difference, or other information associated with the generation of the prediction block. The motion vector difference may be signaled as a delta value between a target motion vector and a motion vector of the texture components, or as a delta value between the target motion vector (that is, the motion vector of the block being coded) and a predictor from neighboring motion vectors for the block (e.g., a PU of a CU). Following the entropy coding by entropy coding unit 46, the encoded video and syntax elements may be transmitted to another device or archived (for example, in memory 34) for later transmission or retrieval.

Inverse quantization unit 42 and inverse transform processing unit 44 apply inverse quantization and inverse transformation, respectively, to reconstruct the residual block in the pixel domain, e.g., for later use as a reference block. The reconstructed residual block (labeled “RECON. RESID. BLOCK” in FIG. 2) may represent a reconstructed version of the residual block provided to transform processing unit 38. The reconstructed residual block may differ from the residual block generated by summer 48 due to loss of detail caused by the quantization and inverse quantization operations. Summer 51 adds the reconstructed residual block to the motion compensated prediction block produced by prediction processing unit 32 to produce a reconstructed video block for storage in memory 34. The reconstructed video block may be used by prediction processing unit 32 as a reference block that may be used to subsequently code a block unit in a subsequent video frame or subsequent coded unit.

FIG. 5 is a diagram of one example of a MVC (MVC) prediction structure for multi-view video coding. The MVC prediction structure may, in general, be used for MVC plus depth applications, but further include the refinement whereby a view may include both a texture component and a depth component. Some basic MVC aspects are described below. MVC is an extension of H.264/AVC, and a 3DVC extension to H.264/AVC makes use of various aspects of MVC but further includes both texture and depth components in a view. The MVC prediction structure includes both inter-picture prediction within each view and inter-view prediction. In FIG. 5, predictions are indicated by arrows, where the pointed-to object uses the pointed-from object for prediction reference. The MVC prediction structure of FIG. 5 may be used in conjunction with a time-first decoding order arrangement. In a time-first decoding order, each access unit may be defined to contain coded pictures of all the views for one output time instance. The decoding order of access units may not be identical to the output or display order.

In MVC, the inter-view prediction is supported by disparity motion compensation, which uses the syntax of the H.264/AVC motion compensation, but allows a picture in a different view to be put as a reference picture. Coding of two views could be supported also by MVC. In one example, one or more of the coded views coded may include destination views synthesized by processing an MPU associating one depth pixel with multiple luma pixels and one or multiple chroma pixels of each chroma component in accordance with this disclosure. In any event, an MVC encoder may take more than two views as a 3D video input and an MVC decoder can decode multi-view representation. A renderer within an MVC decoder can decode 3D video content with multiple views.

Pictures in the same access unit (i.e., with the same time instance) can be inter-view predicted in MVC. When coding a picture in one of the non-base views, a picture may be added into a reference picture list if it is in a different view but within a same time instance. An inter-view prediction reference picture may be put in any position of a reference picture list, just like any inter prediction reference picture.

In MVC, inter-view prediction may be realized as if the view component in another view is an inter prediction reference. The potential inter-view references may be signaled in the Sequence Parameter Set (SPS) MVC extension. The potential inter-view references may be modified by the reference picture list construction process, which enables flexible ordering of the inter prediction or inter-view prediction references.

A bitstream may be used to transfer MVC plus depth block units and syntax elements between, for example, source device 12 and destination device 14 of FIG. 1. The bitstream may comply with the coding standard ITU H.264/AVC, and in particular, follows a MVC bitstream structure. That is, in some examples, the bitstream conforms to or is at least compatible with the MVC extension of H.264/AVC. In other examples, the bitstream conforms to an MVC extension of HEVC or multiview extension of another standard. In still other examples, other coding standards are used.

In general, as examples, the bitstream may be formulated according to the MVC+D 3DVC extension to H.264/AVC, the 3D-AVC extension to H.264/AVC, the MVC-HEVC extension, the 3D-HEVC extension, or the like, or other standards where DIBR may be useful. In the H.264/AVC standard, Network Abstraction Layer (NAL) units are defined to provide a “network-friendly” video representation addressing applications such as video telephony, storage, or streaming video. NAL units can be categorized to Video Coding Layer (VCL) NAL units and non-VCL NAL units. VCL units may contain a core compression engine and comprise block, macroblock (MB), and slice levels. Other NAL units are non-VCL NAL units.

In a 2D video encoding example, each NAL unit contains a one byte NAL unit header and a payload of varying size. Five bits are used to specify the NAL unit type. Three bits are used for nal_ref_idc, which indicates how important the NAL unit is in terms of being referenced by other pictures (NAL units). For example, setting nal_ref_idc equal to 0 means that the NAL unit is not used for inter prediction. As H.264/AVC is extended to support 3DVC, the NAL header may be similar to that of the 2D scenario. For example, one or more bits in the NAL unit header are used to identify that the NAL unit is a four-component NAL unit.

NAL unit headers may also be used for MVC NAL units. However, in MVC, the NAL unit header structure may be retained except for prefix NAL units and MVC coded slice NAL units. MVC coded slice NAL units may comprise a four-byte header and the NAL unit payload, which may include a block unit such as coded block 8 of FIG. 1. Syntax elements in MVC NAL unit header may include priority_id, temporal_id, anchor_pic_flag, view_id, non_idr_flag and inter_view_flag. In other examples, other syntax elements are included in an MVC NAL unit header.

The syntax element anchor_pic_flag may indicate whether a picture is an anchor picture or non-anchor picture. Anchor pictures and all the pictures succeeding it in the output order (i.e., display order) can be correctly decoded without decoding of previous pictures in the decoding order (i.e., bitstream order) and thus can be used as random access points. Anchor pictures and non-anchor pictures can have different dependencies, both of which may be signaled in the sequence parameter set.

The bitstream structure defined in MVC may be characterized by two syntax elements: view_id and temporal_id. The syntax element view_id may indicate the identifier of each view. This identifier in NAL unit header enables easy identification of NAL units at the decoder and quick access of the decoded views for display. The syntax element temporal_id may indicate the temporal scalability hierarchy or, indirectly, the frame rate. For example, an operation point including NAL units with a smaller maximum temporal_id value may have a lower frame rate than an operation point with a larger maximum temporal_id value. Coded pictures with a higher temporal_id value typically depend on the coded pictures with lower temporal_id values within a view, but may not depend on any coded picture with a higher temporal_id.

The syntax elements view_id and temporal_id in the NAL unit header may be used for both bitstream extraction and adaptation. The syntax element priority_id may be mainly used for the simple one-path bitstream adaptation process. The syntax element inter_view_flag may indicate whether this NAL unit will be used for inter-view predicting another NAL unit in a different view.

MVC may also employ sequence parameter sets (SPSs) and include an SPS MVC extension. Parameter sets are used for signaling in H.264/AVC. Sequence parameter sets comprise sequence-level header information. Picture parameter sets (PPSs) comprise the infrequently changing picture-level header information. With parameter sets, this infrequently changing information is not always repeated for each sequence or picture, hence coding efficiency is improved. Furthermore, the use of parameter sets enables out-of-band transmission of the header information, avoiding the need of redundant transmissions for error resilience. In some examples of out-of-band transmission, parameter set NAL units are transmitted on a different channel than the other NAL units. In MVC, a view dependency may be signaled in the SPS MVC extension. All inter-view prediction may be done within the scope specified by the SPS MVC extension.

FIG. 6 is a block diagram illustrating an example of the video decoder 28 of FIG. 1 in further detail, according to techniques of the present disclosure. Video decoder 28 is one example of a specialized video computer device or apparatus referred to herein as a “coder.” As shown in FIG. 5, video decoder 28 corresponds to video decoder 28 of destination device 14. However, in other examples, video decoder 28 corresponds to a different device. In further examples, other units (such as, for example, other encoder/decoder (CODECS)) can also perform similar techniques as video decoder 28.

Video decoder 28 includes an entropy decoding unit 52 that entropy decodes the received bitstream to generate quantized coefficients and the prediction syntax elements. The bitstream includes coded blocks having texture components and a depth component for each pixel location in order to render a 3D video and syntax elements. The prediction syntax elements includes at least one of a coding mode, one or more motion vectors, information identifying an interpolation technique used, coefficients for use in interpolation filtering, and other information associated with the generation of the prediction block.

The prediction syntax elements, e.g., the coefficients, are forwarded to prediction processing unit 55. Prediction processing unit 55 includes a depth syntax prediction module 66. If prediction is used to code the coefficients relative to coefficients of a fixed filter, or relative to one another, prediction processing unit 55 decodes the syntax elements to define the actual coefficients. Depth syntax prediction module 66 predicts depth syntax elements for the depth view components from texture syntax elements for the texture view components.

If quantization is applied to any of the prediction syntax elements, inverse quantization unit 56 removes such quantization. Inverse quantization unit 56 may treat the depth and texture components for each pixel location of the coded blocks in the encoded bitstream differently. For example, when the depth component was quantized differently than the texture components, inverse quantization unit 56 processes the depth and texture components separately. Filter coefficients, for example, may be predictively coded and quantized according to this disclosure, and in this case, inverse quantization unit 56 is used by video decoder 28 to predictively decode and de-quantize such coefficients.

Prediction processing unit 55 generates prediction data based on the prediction syntax elements and one or more previously decoded blocks that are stored in memory 62, in much the same way as described in detail above with respect to prediction processing unit 32 of video encoder 22. In particular, prediction processing unit 55 performs one or more of the MVC plus depth techniques, or other depth-based coding techniques, of this disclosure during motion compensation to generate a prediction block incorporating depth components as well as texture components. The prediction block (as well as a coded block) may have different precision for the depth components versus the texture components. For example, the depth components may have quarter-pixel precision while the texture components have full-integer pixel precision. As such, one or more of the techniques of this disclosure is used by video decoder 28 in generating a prediction block. In some examples, prediction processing unit 55 may include a motion estimation unit, a motion compensation unit, and an intra-coding unit. The motion compensation, motion estimation, and intra-coding units are not shown in FIG. 5 for simplicity and ease of illustration.

Inverse quantization unit 56 inverse quantizes, i.e., de-quantizes, the quantized coefficients. The inverse quantization process is a process defined for H.264 decoding or for any other decoding standard. Inverse transform processing unit 58 applies an inverse transform, e.g., an inverse DCT or conceptually similar inverse transform process, to the transform coefficients in order to produce residual blocks in the pixel domain. Summer 64 sums the residual block with the corresponding prediction block generated by prediction processing unit 55 to form a reconstructed version of the original block encoded by video encoder 22. If desired, a deblocking filter is also applied to filter the decoded blocks in order to remove blockiness artifacts. The decoded video blocks are then stored in memory 62, which provides reference blocks for subsequent motion compensation and also produces decoded video to drive display device (such as device 28 of FIG. 1).

The decoded video may be used to render 3D video. One or more views of the 3D video rendered from the decoded video provided by video decoder 28 can be synthesized in accordance with this disclosure. Video decoder 28 can, for example, include DIBR module 110, which can function in a similar manner as described above with reference to FIG. 3. Thus, in one example, DIBR module 110 can synthesize one or more views by processing MPUs of a reference view included in the decoded video data, in which each MPU associates one depth pixel with multiple luma pixels and one or more chroma pixels for each chroma component of the texture component of the reference view.

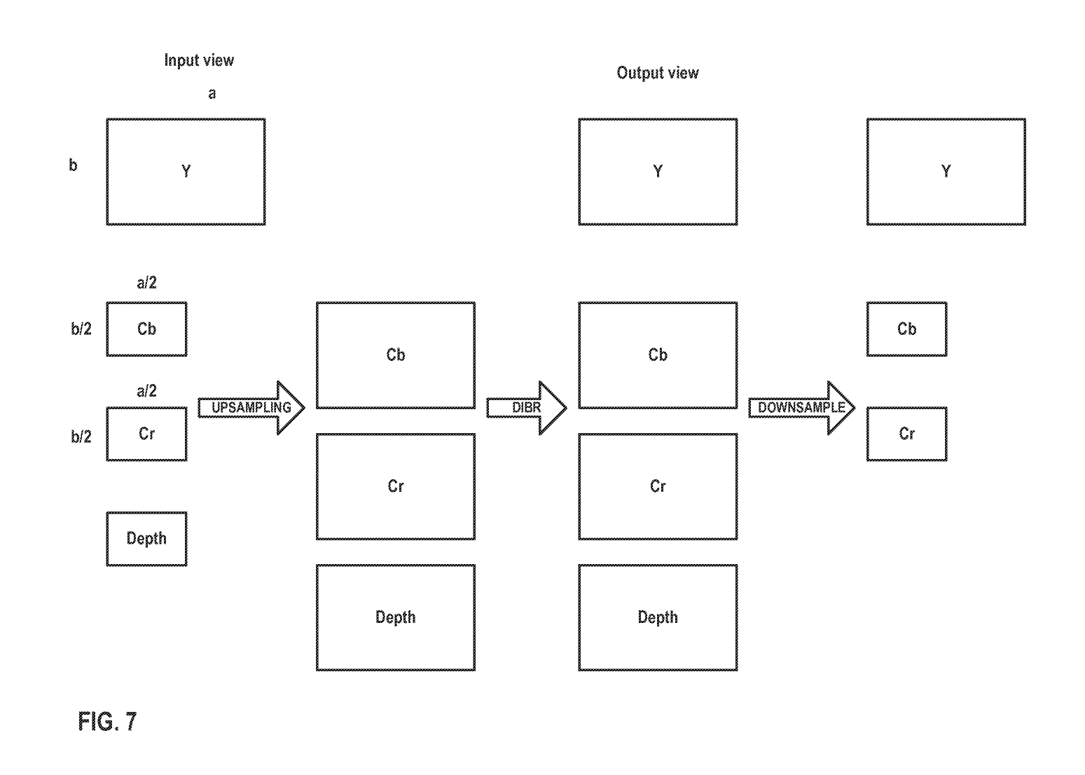

FIG. 7 is a conceptual flowchart that illustrates upsampling which may be performed in some examples for depth image based rendering (DIBR). Such upsampling may require additional processing power and computation cycles, which may be less efficient utilization of power and processing resources. For instance, in order to guarantee each texture component to be the same as depth, the chroma components as well as the depth image may have to be upsampled to the same resolution as luma. After warping and hole-filling, the chroma components are downsampled. In FIG. 7, warping may be performed in the 4:4:4 domain.

The techniques described in this disclosure may overcome the issues described with reference to and illustrated in FIG. 7, and support the asymmetric resolution for depth image and texture image, for example, when a depth image has equal or lower resolution as the chroma components of a texture image, and lower resolution as the luma components of the texture image.

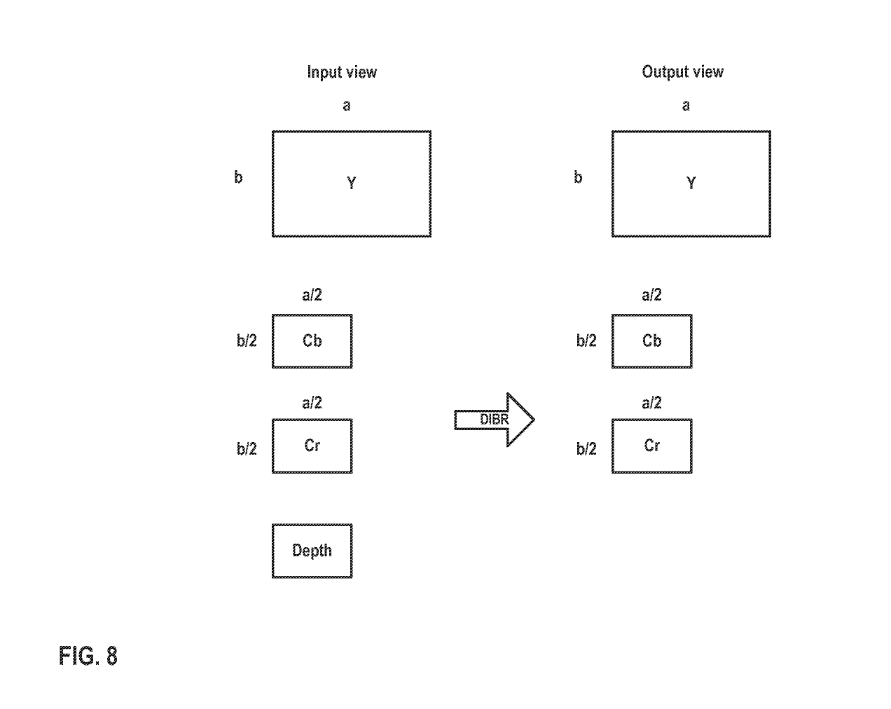

For example, the depth component can have the same resolution as that of both chroma components and both depth and chroma can have one quarter of the luma component. Such an example is illustrated in FIG. 8, which is a conceptual flowchart illustrating an example of warping for the quarter resolution case. In this example, FIG. 8 may be considered as warping in the 4:2:0 domain with the same size of depth and chroma.

An example implementation is provided below, which is based on the latest working draft of “Working Draft 1 of AVC compatible video with depth information.” In this example, the resolution of the depth is a quarter resolution of texture luma.

### A.1.1.1 3DVC Decoding Process for View Synthesis Reference Component Generation

This process may be invoked when decoding a texture view component which refers to a synthetic reference component. Inputs of this process are a decoded texture view component srcTexturePicY and, if chroma_format_idc is equal to 1 srcTexturePicCb and srcTexturePicCr, and a decoded depth view component srcDepthPic of the same view component pair. Output of this process is a sample array of a synthetic reference component vspPic consisting of 1 sample array vspPicY when chroma_format_idc is equal to 0, or 3 sample arrays vspPicY, vspPicCb, and vspPicCr when chroma_format_idc is equal to 1.

For the derivation of output, the following ordered steps are specified.

The picture warping and hole filling process specified in subclause A.1.1.1.2 is invoked with srcPicY set to srcTexturePictureY, srcPicCb set to normTexturePicCb (when chroma_format_idc is equal to 1), srcPicCr set to normTexturePicCr (when chroma_format_idc is equal to 1), and depPic set to normDepthPic as inputs, and the output assigned to vspPicY, and if chroma_format_idc is equal to 1, vspPicCb and vspPicCr.

### A.1.1.1.2 Picture Warping and Hole-Filing Process

Inputs of this process are decoded a luma component of the texture view component srcPicY and, if chroma_format_idc is equal to 1 two chroma components srcPicCb and srcPicCr, and a depth picure depPic. All these pictures have the same spatial resolution. Outputs of this process is a sample array of a synthetic reference component vspPic consisting of 1 sample array vspPicY when chroma_format_idc is equal to 0, or 3 sample arrays vspPicY, vspPicCb, and vspPicCr when chroma_format_idc is equal to 1. If ViewIdTo3DVAcquisitionParamIndex (view_id of the current view) is smaller than ViewIdTo3DVAcquisitionParamIndex (view_id of the input texture view component), the warping direction WarpDir is set to 0, otherwise, WarpDir is set to 1.

Invoke A.1.1.1.2.1 to generate the look up table dispTable.

For each row i, i from 0 to height-1, (wherein height is the height of the depth array), inclusive, A.1.1.1.2.2 is invoked with the 2*i-th row and (2*i+1)-th row of srcPicY, srcPicYRow0, srcPicYRow1, the i-th row of scrPicCb, scrPicCbRow, the i-th row of scrPicCr, scrPicCrRow, the i-th row of depth picture, depPicRow and WarpDir as inputs and the i-th row of vspPicY, vspPicYRow, the 2*i-th row and (2*i+1)-th row of vspPicCb, vspPicCbRow, and the i-th row of vspPicCr, vspPicCrRow as outputs.

A.1.1.2.1 Look Up Table from Disparity to Depth Generation Process

For each d from 0 to 255, dispTable[d] is set as follows:
dispTable[d]=Disparity(d, ZNear[frame_num, index], ZFar[frame_num, index], FocalLengthX[frame_num, index], AbsTX[index]−AbsTX[refIndex]), wherein index and refIndex are derived by the following formulas:
index=ViewIdTo3DVAcquisitionParamIndex (view_id of the current view)
refIndex=ViewIdTo3DVAcquisitionParamIndex (ViewId of the input texture view component)

### A.1.1.1.2.2 Row Warping and Hole-Filing Process

Inputs to this process is two rows of reference luma samples, srcPicYRow0, srcPicYRow1, a row of reference cb samples, scrPicCbRow and a row of reference cr samples, scrPicCrRow, a row of depth samples, depPicRow, and a warping direction WarpDir. Outputs of this process is two rows of target luma samples, vspPicYRow0, vspPicYRow1, a row of target cb samples, vspPicCbRow, and a row of target cr samples, vspPicCrRow.

Set PixelStep as follows: PixelStep=WarpDir ?−1:1. A tempDepRow is allocated with the same size as depPicRow. Each value of tempDepRow is set to −1. Set RowWidth to be the width of the depth sample row.

The following steps are carried out in order.
1. Set j=0, prevK=0, jDir=(RowWidth−1)*WarpDir
2. Set k=jDir+dispTable[depPicRow [jDir]]
3. If k is smaller than RowWidth and k is equal or larger than 0, and tempDepRow[k] is less than depPicRow[jDir], do the following; otherwise, go to step 4.
   tempDepRow[k] is set to depPicRow[jDir].
   Invoke pixel warping process A.1.1.1.2.2.1 with inputs including all the inputs of this sub-clause and position jDir and the position k.
   If (k−preK) is equal to PixelStep, go to step 4.
   Otherwise, if PixelStep* (k−prevK) is larger than 1
      Invoke A.1.1.1.2.2.2 to fill holes with inputs including all the inputs of this sub-clause and a position pair of (prevK+PixelStep, k−PixelStep);
   Otherwise, (k is smaller than or equal to prevK when WarpDir is 0, or k is bigger than or equal to prevK when WarpDir is 1), the following steps apply in order:
      When k is not equal to prevK, for each pos from k+PixelStep to prevK, inclusive, set tempDepRow[pos] to −1.
      When k is larger than 0 and smaller than RowWidth −1 and tempDepRow[k−PixelStep] is equal to −1, set variable holePos equal to k−PixelStep and iteratively decrease holePos by PixelStep until one of the conditions is true:
         holePos is equal to 0 or holePos is equal to RowWidth−1;
         tempDepRow[holePos] is not equal to −1.
      Invoke A.1.1.1.2.2.2 to fill holes with inputs including all the inputs of this sub-clause and a position pair of (holePos+PixelStep, k−PixelStep);
   Set prevK to k.
4. The following steps apply in order:
   j++.
   Set jDir=jDir+PixelStep.
   If j is equal to RowWidth, go to step 5; otherwise, go to step 2.
5. The following steps apply in order:
   If prevK is unequal to (1−WarpDir)*(RowWidth−1)), invoke A.1.1.1.2.2.2 to fill holes with inputs including all the inputs of this sub-clause and a position pair of (prevK+PixelStep, (1−WarpDir)*(RowWidth−1)).
   Terminate the process.

### A.1.1.1.2.2.1 Pixel Warping Process

Inputs to this process include all the inputs for A.1.1.1.2.2, in addition, a position jDir at the reference sample rows and a position k at the target sample rows. Outputs of this process are modified sample rows of vspPicYRow0, vspPicYRow1, vspPicCbRow, vspPicCrRow, at position k.
vspPicYRow0 [2*k] is set equal to srcPicYRow0 [2*jDir];
vspPicYRow0 [2*k+1] is set equal to srcPicYRow0 [2*jDir+1];
vspPicYRow1 [2*k] is set equal to srcPicYRow1 [2*jDir];
vspPicYRow1 [2*k+1] is set equal to srcPicYRow1 [2*jDir+1];
vspPicCbRow [k] is set equal to srcPicCbRow [jDir];
vspPicCrRow [k] is set equal to srcPicCrRow [jDir].

### A.1.1.12.2.2 Hole Pixel Filing Process

Inputs to this process include all the inputs for I.8.4.2.2, in addition a row of depth samples tempDepRow, a position pair (p1, p2) and the width of the row, RowWidth. Outputs of the process are modified sample rows of vspPicYRow0, vspPicYRow1, vspPicCbRow, vspPicCrRow.

Set posLeft and posRight as follows:
posLeft=(p1<p2?p1, p2);
posRight=(p1<p2?p2, p1).

The posRef is derived as follows:
If posLeft is equal to 0, posRef is set to posRight+1;
Otherwise, if posRight is equal to RowWidth−1, posRef is set to posLeft−1;
Otherwise, if tempDepRow[posLeft −1] is smaller than tempDepRow[posRight +1], posRef is set to posLeft −1;
Otherwise, posRef is set to posRight +1.

For each pos from posLeft to posRight, inclusive, the following apply:

vspPicYRow0[pos*2]=vspPicYRow0[posRef*2];

vspPicYRow0[pos*2+1]=vspPicYRow0[posRef*2+1];

vspPicYRow1[pos*2]=vspPicYRow1[posRef*2];

vspPicYRow1[pos*2+1]=vspPicYRow1[posRef*2+1];

vspPicCbRow[pos]=vspPicCrRow[posRef];

vspPicCbRow[pos]=vspPicCrRow[posRef].

Examples according to this disclosure can provide a number of advantages related to synthesizing views for multi-view video based on a reference view with asymmetrical depth and texture component resolutions. Examples according to this disclosure enable view synthesis using an MPU without the need for upsampling and/or downsampling to artificially create resolution symmetry between depth and texture view components. One advantage of examples according to this disclosure is that one depth pixel can correspond to one and only one MPU, instead of processing pixel by pixel where a the same depth pixel can correspond to and be processed with multiple upsampled or downsampled approximations of luma and chroma pixels in multiple MPUs. In some examples according to this disclosure, multiple luma pixels and one or multiple chroma pixels are associated in one MPU with only one and only one depth value, and the luma and chroma pixels are therefore processed jointly depending on the same logic. In this manner, condition checks during view synthesis in accordance with this disclosure can be greatly decreased.

The term “coder” is used herein to refer to a computer device or apparatus that performs video encoding or video decoding. The term “coder” generally refers to any video encoder, video decoder, or combined encoder/decoder (codec). The term “coding” refers to encoding or decoding. The terms “coded block,” “coded block unit,” or “coded unit” may refer to any independently decodable unit of a video frame such as an entire frame, a slice of a frame, a block of video data, or another independently decodable unit defined according to the coding techniques used.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

1. A method for processing video data, the method comprising:
associating, in a minimum processing unit (MPU), one pixel of a depth image of a reference picture with one or more pixels of a first chroma component of a texture image of the reference picture, wherein the MPU indicates an association of pixels needed to synthesize a pixel in a destination picture, and wherein the destination picture and the texture component of the reference picture when viewed together form a three-dimensional picture;
associating, in the MPU, the one pixel of the depth image with one or more pixels of a second chroma component of the texture image; and
associating, in the MPU, the one pixel of the depth image with a plurality of pixels of a luma component of the texture image, wherein a number of the pixels of the luma component is different than a number of the one or more pixels of the first chroma component and a number of the one or more pixels of the second chroma component.

2. The method of claim 1, further comprising:
processing the MPU to synthesize at least one pixel of the destination picture,
wherein processing the MPU is executed without upsampling at least one of the depth image, the first chroma component of the texture image, and the second chroma component of the texture image.

3. The method of claim 2, wherein processing the MPU comprises:
warping the MPU to the destination picture to generate the at least one pixel of the destination picture from the texture image and the depth image of the reference picture.

4. The method of claim 3, wherein warping the MPU to the destination picture comprises displacing at least one of the one or more pixels of the first chroma component, the one or more pixels of the second chroma component, and the plurality of pixels of the luma component based on the one pixel of the depth component.

5. The method of claim 3, wherein warping the MPU to the destination picture comprises displacing all of the pixels of the first chroma component, the second chroma component, and the luma component based on the one pixel of the depth component.

6. The method of claim 4, wherein warping the MPU to the destination picture comprises horizontally displacing at least one of the one or more pixels of the first chroma component, the one or more pixels of the second chroma component, and the plurality of pixels of the luma component based on the one pixel of the depth component.

7. The method of claim 2, wherein the processing is executed without upsampling the depth image, the first chroma component of the texture image, or the second chroma component of the texture image.

8. The method of claim 2, wherein processing the MPU comprises:
hole-filling a MPU of the destination picture from the MPU that is associated with the depth image and the texture image of the reference picture to generate at least one other pixel in the destination picture.

9. The method of claim 2, wherein processing the MPU comprises:
simultaneously hole-filling a plurality of MPUs of the destination picture from the MPU that is associated with the depth image and the texture image of the reference picture, wherein the hole-filling provides pixel values for a plurality of rows of a luma component, and first and second chroma components of the destination picture.

10. The method of claim 1,
wherein the texture image of the reference picture comprises one picture of a first view of a multi-view video coding (MVC) access unit,
wherein the destination picture comprises a second view of the multi-view video MVC access unit.

11. The method of claim 1, wherein the number of the pixels of the luma component equals four, the number of the one or more pixels of the first chroma component equals one, and the number of the one or more pixels of the second chroma component equals one such that the MPU associates the one pixel of the depth image with one pixel of the first chroma component, one pixel of the second chroma component, and four pixels of the luma component of the texture image.

12. The method of claim 1, wherein the number of the pixels of the luma component equals two, the number of the one or more pixels of the first chroma component equals one, and the number of the one or more pixels of the second chroma component equals one such that the MPU associates the one pixel of the depth image with one pixel of the first chroma component, one pixel of the second chroma component, and two pixels of the luma component of the texture image.

13. An apparatus for processing video data, the apparatus comprising:
at least one processor configured to:
associate, in a minimum processing unit (MPU), one pixel of a depth image of a reference picture with one or more pixels of a first chroma component of a texture image of the reference picture, wherein the MPU indicates an association of pixels needed to synthesize a pixel in a destination picture, and wherein the destination picture and the texture component of the reference picture when viewed together form a three-dimensional picture;
associate, in the MPU, the one pixel of the depth image with one or more pixels of a second chroma component of the texture image; and
associate, in the MPU, the one pixel of the depth image with a plurality of pixels of a luma component of the texture image, wherein a number of the pixels of the luma component is different than a number of the one or more pixels of the first chroma component and a number of the one or more pixels of the second chroma component.

14. The apparatus of claim 13, wherein the at least one processor is configured to:
process the MPU to synthesize at least one pixel of the destination picture,
wherein the at least one processor is configured to process the MPU without upsampling at least one of the depth image, the first chroma component of the texture image, and the second chroma component of the texture image.

15. The apparatus of claim 14, wherein the at least one processor is configured to process the MPU at least by:
warping the MPU to the destination picture to generate the at least one pixel of the destination picture from the texture image and the depth image of the reference picture.

16. The apparatus of claim 15, wherein the at least one processor is configured to warp the MPU at least by displacing at least one of the one or more pixels of the first chroma component, the one or more pixels of the second chroma component, and the plurality of pixels of the luma component based on the one pixel of the depth component.

17. The apparatus of claim 16, wherein the at least one processor is configured to warp the MPU at least by displacing all of the pixels of the first chroma component, the second chroma component, and the luma component based on the one pixel of the depth component.

18. The apparatus of claim 16, wherein the at least one processor is configured to warp the MPU at least by horizontally displacing at least one of the one or more pixels of the first chroma component, the one or more pixels of the second chroma component, and the plurality of pixels of the luma component based on the one pixel of the depth component.

19. The apparatus of claim 14, wherein the at least one processor is configured to process the MPU without upsampling the depth image, the first chroma component of the texture image, or the second chroma component of the texture image.

20. The apparatus of claim 14, wherein the at least one processor is configured to process the MPU at least by:
hole-filling a MPU of the destination picture from the MPU that is associated with the depth image and the texture image of the reference picture to generate at least one other pixel in the destination picture.

21. The apparatus of claim 14, wherein the at least one processor is configured to process the MPU at least by:
simultaneously hole-filling a plurality of MPUs of the destination picture from the MPU that is associated with the depth image and the texture image of the reference picture, wherein the hole-filling provides pixel values for a plurality of rows of a luma component, and first and second chroma components of the destination picture.

22. The apparatus of claim 13,
wherein the texture image of the reference picture comprises one picture of a first view of a multi-view video,
wherein the destination picture comprises a second view of the multi-view video, and
wherein the multi-view video forms a three-dimensional video when viewed.

23. The apparatus of claim 13, wherein the number of the pixels of the luma component equals four, the number of the one or more pixels of the first chroma component equals one, and the number of the one or more pixels of the second chroma component equals one such that the MPU associates the one pixel of the depth image with one pixel of the first chroma component, one pixel of the second chroma component, and four pixels of the luma component of the texture image.

24. The apparatus of claim 13, wherein the number of the pixels of the luma component equals two, the number of the one or more pixels of the first chroma component equals one, and the number of the one or more pixels of the second chroma component equals one such that the MPU associates the one pixel of the depth image with one pixel of the first chroma component, one pixel of the second chroma component, and two pixels of the luma component of the texture image.

25. An apparatus for processing video data, the apparatus comprising:
means for associating, in a minimum processing unit (MPU), one pixel of a depth image of a reference picture with one or more pixels of a first chroma component of a texture image of the reference picture, wherein the MPU indicates an association of pixels needed to synthesize a pixel in a destination picture, and wherein the destination picture and the texture component of the reference picture when viewed together form a three-dimensional picture;
means for associating, in the MPU, the one pixel of the depth image with one or more pixels of a second chroma component of the texture image; and
means for associating, in the MPU, the one pixel of the depth image with a plurality of pixels of a luma component of the texture image, wherein a number of the pixels of the luma component is different than a number of the one or more pixels of the first chroma component and a number of the one or more pixels of the second chroma component.

26. A computer-readable storage medium having stored thereon instructions that when executed cause one or more processors to perform operations comprising:
associating, in a minimum processing unit (MPU), one pixel of a depth image of a reference picture with one or more pixels of a first chroma component of a texture image of the reference picture, wherein the MPU indicates an association of pixels needed to synthesize a pixel in a destination picture, and wherein the destination picture and the texture component of the reference picture when viewed together form a three-dimensional picture;
associating, in the MPU, the one pixel of the depth image with one or more pixels of a second chroma component of the texture image; and
associating, in the MPU, the one pixel of the depth image with a plurality of pixels of a luma component of the texture image, wherein a number of the pixels of the luma component is different than a number of the one or more pixels of the first chroma component and a number of the one or more pixels of the second chroma component.

27. A video encoder comprising:
at least one processor configured to:
associate, in a minimum processing unit (MPU), one pixel of a depth image of a reference picture with one or more pixels of a first chroma component of a texture image of the reference picture, wherein the MPU indicates an association of pixels needed to synthesize a pixel in a destination picture, and wherein the destination picture and the texture component of the reference picture when viewed together form a three-dimensional picture;
associate, in the MPU, the one pixel of the depth image with one or more pixels of a second chroma component of the texture image;
associate, in the MPU, the one pixel of the depth image with a plurality of pixels of a luma component of the texture image, wherein a number of the pixels of the luma component is different than a number of the one or more pixels of the first chroma component and a number of the one or more pixels of the second chroma component;
process the MPU to synthesize at least one MPU of the destination picture; and
encode the MPU of the reference picture and the at least one MPU of the destination picture,
wherein the encoded MPUs form a portion of a coded video bitstream comprising multiple views.

28. A video decoder comprising:
an input interface configured to receive a coded video bitstream comprising one more views; and
at least one processor configured to:
decode the coded video bitstream, wherein the decoded video bitstream comprises a plurality of pictures, each of which comprises a depth image and a texture image;
select a reference picture from the plurality of pictures of the decoded video bitstream;
associate, in a minimum processing unit (MPU), one pixel of a depth image of a reference picture with one or more pixels of a first chroma component of a texture image of the reference picture, wherein the MPU indicates an association of pixels needed to synthesize a pixel in a destination picture, and wherein the destination picture and the texture component of the reference picture when viewed together form a three-dimensional picture;
associate, in the MPU, the one pixel of the depth image with one or more pixels of a second chroma component of the texture image;
associate, in the MPU, the one pixel of the depth image with a plurality of pixels of a luma component of the texture image, wherein a number of the pixels of the luma component is different than a number of the one or more pixels of the first chroma component and a number of the one or more pixels of the second chroma component; and
process the MPU to synthesize at least one MPU of the destination picture.
